(19) United States
(12) Patent Application Publication
(10) Pub. No.: US 2009/0240519 A1
(43) Pub. Date: Sep. 24, 2009

(54) DWELL-UNIT-MANAGEMENT SUPPORTING SYSTEM, DWELL-UNIT-MANAGEMENT SUPPORTING METHOD, COMPUTER-READABLE RECORDING MEDIUM, SERVER AND MULTIPLE FUNCTION PROCESSING MACHINE

(76) Inventors: Tomoyuki ICHIKAWA, Kanagawa (JP); Yoshiaki Atomiya, Tokyo (JP); Tadashi Honda, Kanagawa (JP); Sadao Takahashi, Kanagawa (JP); Ayako Fujimoto, Tokyo (JP); Takuma Katori, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/399,413

(22) Filed: Mar. 6, 2009

(30) Foreign Application Priority Data
Mar. 19, 2008 (JP) 2008-072334

(51) Int. Cl. G06Q 10/00; G06F 3/12

(52) U.S. Cl. 705/1; 358/1.15

(57) ABSTRACT

As receiving information for specifying a dwell unit and a request of creating an inspection list, a dwell unit information server creates an inspection list for the dwell unit in response to the request. A multiple function processing machine prints out the inspection list, and reads the inspection list on which a defective equipment is written. The multiple function processing machine extracts handwritten information from read-out information, and transmits the extracted information to the dwell unit information server together with code information printed on the inspection list. The dwell unit information server extracts an equipment needing inspection based on the code information and the handwritten information, and transmits a work instruction which instructs maintenance/repair of the equipment to a maintenance/repair responsible company responsible for the extracted equipment.

### BACKGROUND OF THE INVENTION

1. Field of the Invention

The present invention relates to a dwell-unit-management supporting system and the like which supports after-sales services to a dweller of a collective housing which is carried out by a construction company or a management company of the collective housing.

2. Description of the Related Art

When there occurs a failure or a defect in a household equipment, a dweller of each dwelling unit of a condominium building contacts a construction company or a management company entrusted by the construction company to correspond to dwellers to request a repair service. For example, Unexamined Japanese Patent Application KOKAI Publication No. 2002-269208 discloses a service information system providing a web page that posts a consultation form into which a consultation for a defect can be input, so that a dweller can consult for a defect at anytime and at a convenient time.

This web page, however, does not provide a consultation form individually corresponding to houses of dwellers. Moreover, it is difficult for elderly people to use this web page because they are not familiar with operation of a computer and do not know how to operate.

In apartment houses like condominium housings, an inspection is regularly carried out based on the content of a report from a dweller, and maintenance and repair (m/r) are carried out based on the inspection result. At the time of inspection, a construction company creates inspection sheets for allowing a dweller to fill out a failure and to notify the construction company by the total number of family units. However, because there are several tens of types of room arrangements depending on condominium housings, it takes a time and an effort to manually create inspection sheets corresponding to individual family units of all condominium housings constructed by the construction company.

Based on the inspection sheets sent back from the dwellers, the construction company asks a subcontract company to do maintenance and repair. However, in the case of condominium housing, it takes lots of time to collect filled-out inspection sheets to create an instruction letter to the subcontract company in accordance with the contents of the inspection sheets.

The present invention has been made in view of the foregoing circumstances, and it is an object of the present invention to provide a dwell-unit-management supporting system or the like which supports after-sales service to a dweller which is executed by a construction company or a management company of an apartment house.

### SUMMARY OF THE INVENTION

To achieve the object, a dwell-unit-management supporting system according to the first aspect of the present invention is a dwell-unit-management supporting system that comprises a multiple function processing machine and a server providing composition information of a fill-in sheet for dwell unit management to the multiple function processing machine, and wherein:

the composition information includes code information;

the multiple function processing machine comprises:
a printer unit that receives the composition information from the server and prints a fill-in sheet on the basis of the composition information;
a reader unit that reads the fill-in sheet which is printed out by the printer unit and on which a character or a graphic symbol is written;
a read-out information analysis unit that analyzes read-out information read by the reader unit, and extracts the code information and handwritten information, including a character or a graphic symbol, from the read-out information; and
an information transmission unit that transmits the extracted code information and handwritten information when a predetermined transmission condition is satisfied; and

the server comprises:
a reception unit that receives the code information and the handwritten information from the multiple function processing machine; and
a processing unit that executes a predetermined dwell-unit-management supporting process based on the code information and handwritten information both received by the reception unit.

In the foregoing dwell-unit-management supporting system,

the code information may include vendor identification information for specifying a management company of the server, and

the information transmission unit may transmit the extracted code information and handwritten information upon satisfying a condition that the vendor identification information included in the code information received by the reception unit matches identification information of a vendor which specifies the management company of the server.

In the foregoing dwell-unit-management supporting system,

the server may further comprise a responsible company information storing unit that stores each equipment of a dwell unit, company identification information for specifying a company responsible for maintenance/repair of the equipment, and contact information of the responsible company in association with one another for each dwell unit subjected to management, and

the processing unit may determine whether or not the handwritten information includes information indicating that an inspection-desired equipment at a specific dwell unit is filled based on the received code information and handwritten information, and when determining that such information is included, as the dwell-unit-management supporting process, may specify an inspection-desired equipment in the dwell unit based on the handwritten information, may search identification information of a company responsible for maintenance/repair of the specified inspection-desired equipment from the responsible company information storing unit, may create a work instruction instructing inspection of the inspection-desired equipment to the responsible company identified by the searched company identification information, and may transmit the work instruction to the contact information of the responsible company.

In the foregoing dwell-unit-management supporting system,

the server may further comprise a maintenance/repair history information storing unit that stores a work content done by a maintenance/repair responsible company in accordance with the work instruction for each dwell unit subjected to management, and

the processing unit may determine whether or not the handwritten information includes information indicating that a maintenance/repair work content at a dwell unit is filled based on the received code information and handwritten information, and when determining that such information is included, as the dwell-unit-management supporting process, may extract a maintenance/repair work content at the dwell unit based on the handwritten information, and may store the extracted information in the maintenance/repair history information storing unit.

In the foregoing dwell-unit-management supporting system,

the server may further comprise:

a dwell unit information storing unit that stores identification information of a dwell unit and information on the dwell unit in association with each other for each dwell unit subjected to management; and

a composition information creation unit that searches information on a dwell unit corresponding to identification information in the dwell unit information storing unit when a request of creating the document composition information including the identification information of the dwell unit is received, and creates the composition information including the code information based on the information on the dwell unit.

In the foregoing dwell-unit-management supporting system,

information on a dwell unit may include floor plan information of the dwell unit and inspection list information, and

the composition information may be constituted in a manner that that a floor plan of a dwell unit and an inspection list for the dwell unit on the basis of the floor plan information and the inspection list information are printed on the fill-in sheet.

A dwell-unit-management supporting method according to the second aspect of the present invention is a dwell-unit-management supporting method carried out by a multiple function processing machine, and a server that provides composition information of a fill-in sheet for dwell unit management to the multiple function processing machine, wherein:

the composition information includes code information; and

the method comprises:
a print step of receiving the composition information created by the server, and printing a fill-in sheet based on the composition information using the multiple function processing machine;
a reading step of reading the fill-in sheet which is printed and on which a character or a graphic symbol is written using the multiple function processing machine;
a read-out information analyzing step of analyzing read information read out using the multiple function processing machine, and extracting the code information and handwritten information including a character or a graphic symbol from the read information using the multiple function processing machine;
an information transmission step of transmitting the extracted code information and handwritten information using the multiple function processing machine when a predetermined transmission condition is satisfied;
a reception step of receiving the code information and the handwritten information from the multiple function processing machine using the server; and
a processing step of executing a predetermined dwell-unit-management supporting process based on the received code information and handwritten information using the server.

A computer-readable recording medium according to the third aspect of the present invention is a computer-readable recording medium storing a program that allows a computer to function as a server which provides composition information of a fill-in sheet for dwell unit management to a multiple function processing machine, wherein:

the composition information includes code information; and

the server comprises:
a reception unit that receives code information included in a fill-in sheet provided by the multiple function processing machine and handwritten information on a character or a graphic symbol which is written on the fill-in sheet from the multiple function processing machine; and
a processing unit that executes a predetermined dwell-unit-management supporting process based on the code information and the handwritten information both received by the reception unit.

A computer-readable recording medium according to the fourth aspect of the present invention is a computer-readable recording medium storing a program that allows a computer to function as a multiple function processing machine to which composition information of a fill-in sheet for dwell unit management is provided from a server, wherein:

the composition information includes code information;

the multiple function processing machine comprises:
a printer unit that receives the composition information from the server and prints a fill-in sheet on the basis of the composition information;
a reader unit that reads the fill-in sheet which is printed out by the printer unit and on which a character or a graphic symbol is written;
a read-out information analysis unit that analyzes read-out information read by the reader unit, and extracts the code information and handwritten information on a character or a graphic symbol written on the fill-in sheet from the read-out information; and
an information transmission unit that transmits the extracted code information and handwritten information when a predetermined transmission condition is satisfied.

A server according to the fifth aspect of the present invention is a server that provides composition information of a fill-in sheet for dwell unit management to a multiple function processing machine, wherein

the composition information includes code information; and

the server comprises:
a reception unit that receives code information included in a fill-in sheet provided to the multiple function processing machine and handwritten information on a character or a graphic symbol written on the fill-in sheet from the multiple function processing machine; and
a processing unit that executes a predetermined dwell-unit-management supporting process based on the code information and the handwritten information both received by the reception unit.

A multiple function processing machine according to the sixth aspect of the present invention is a multiple function processing machine that is connected to a server which provides composition information of a fill-in sheet for dwell unit management, wherein

the composition information includes code information;

the multiple function processing machine comprises:
a printer unit that receives the composition information from the server and prints a fill-in sheet on the basis of the composition information;
a reader unit that reads the fill-in sheet which is printed out by the printer unit and on which a character or a graphic symbol is written;
a read-out information analysis unit that analyzes read-out information read by the reader unit, and extracts the code information and handwritten information on a character or a graphic symbol written on the fill-in sheet from the read-out information; and
an information transmission unit that transmits the extracted code information and handwritten information when a predetermined transmission condition is satisfied.

According to the present invention, it is possible to provide a dwell-unit-management supporting system and the like which supports after-sales services to a dweller of a collective housing which is carried out by a construction company or a management company of the collective housing.

### BRIEF DESCRIPTION OF THE DRAWINGS

The object and other objects and advantages of the present invention will become more apparent upon reading of the following detailed description and the accompanying drawings in which:

FIG. 1 is a block diagram showing a structural example of a dwell-unit-management supporting system according to an embodiment of the present invention;

FIG. 2 is a workflow of a periodical maintenance/repair inspection work for a condominium building using the dwell-unit-management supporting system according to the embodiment of the present invention;

FIG. 3 is a diagram showing an example of an inspection sheet;

FIG. 4 is a diagram showing an example of a filled-out inspection sheet;

FIG. 5 is a diagram showing an example of a work request form;

FIG. 6 is a diagram showing an example of a work request form;

FIG. 7 is a block diagram showing the general structure of a dwell unit information server;

FIG. 8 is a block diagram showing the general structure of a multiple function processing machine;

FIG. 9A is a diagram showing a structural example of a client information storing unit;

FIG. 9B is a diagram showing a structural example of a dwell-unit information storing unit;

FIG. 9C is a diagram showing a structural example of a responsible company information storing unit;

FIG. 10A is a diagram showing a structural example of a document information storing unit;

FIG. 10B is a diagram showing a structural example of a maintenance/repair history information storing unit;

FIG. 10C is a diagram showing a structural example of a condominium building information storing unit;

FIG. 10D is a diagram showing a company information storing unit;

FIG. 11A is a diagram showing an example of a main menu of a dwell-unit-management supporting program for a construction company which is provided by the dwell unit information server;

FIG. 11B is a diagram showing an example of a main menu the dwell-unit-management supporting program for a condominium building resident which is provided by the dwell unit information server;

FIG. 11C is a diagram showing an example of a main menu of the dwell-unit-management supporting program for a maintenance/repair subcontract company which is provided by the dwell unit information server;

FIG. 12 is a diagram showing a structural example of code information;

FIG. 13 is a flowchart for explaining an inspection sheet creation process;

FIG. 14 is a flowchart for explaining a creation process of document composition information for an inspection sheet;

FIG. 15 is a flowchart for explaining an inspection sheet printing process;

FIG. 16 is a flowchart for explaining an inspection sheet reading process;

FIG. 17 is a flowchart for explaining a work instruction automatic creation process by the dwell unit information server;

FIG. 18 is a flowchart for explaining a work instruction creation process;

FIG. 19 is a flowchart for explaining a work registering process; and

FIG. 20 is a diagram showing an example of a list for requesting a service.

### DETAILED DESCRIPTION OF THE PREFERRED EMBODIMENT

An explanation will be given of a dwell-unit-management supporting system according to the preferred embodiment of the present invention with reference to accompanying drawings.

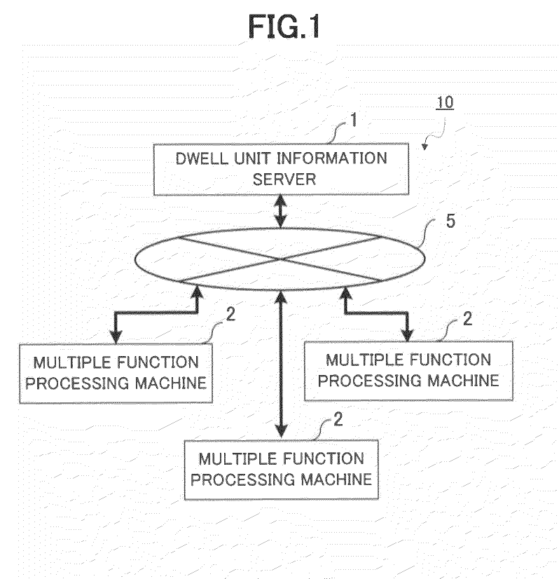

FIG. 1 is a diagram showing the structure of a dwell-unit-management supporting system 10 according to the embodiment of the present invention. As shown in FIG. 1, the dwell-unit-management supporting system 10 has a dwell unit information server 1 and a plurality of multiple function processing machines 2. The dwell unit information server 1 and the multiple function processing machine 2 are connected together via a network 5. The dwell unit information server 1 is accessible from a terminal device of a construction company and a terminal device of a maintenance/repair subcontract company via the network 5.

(Workflow)

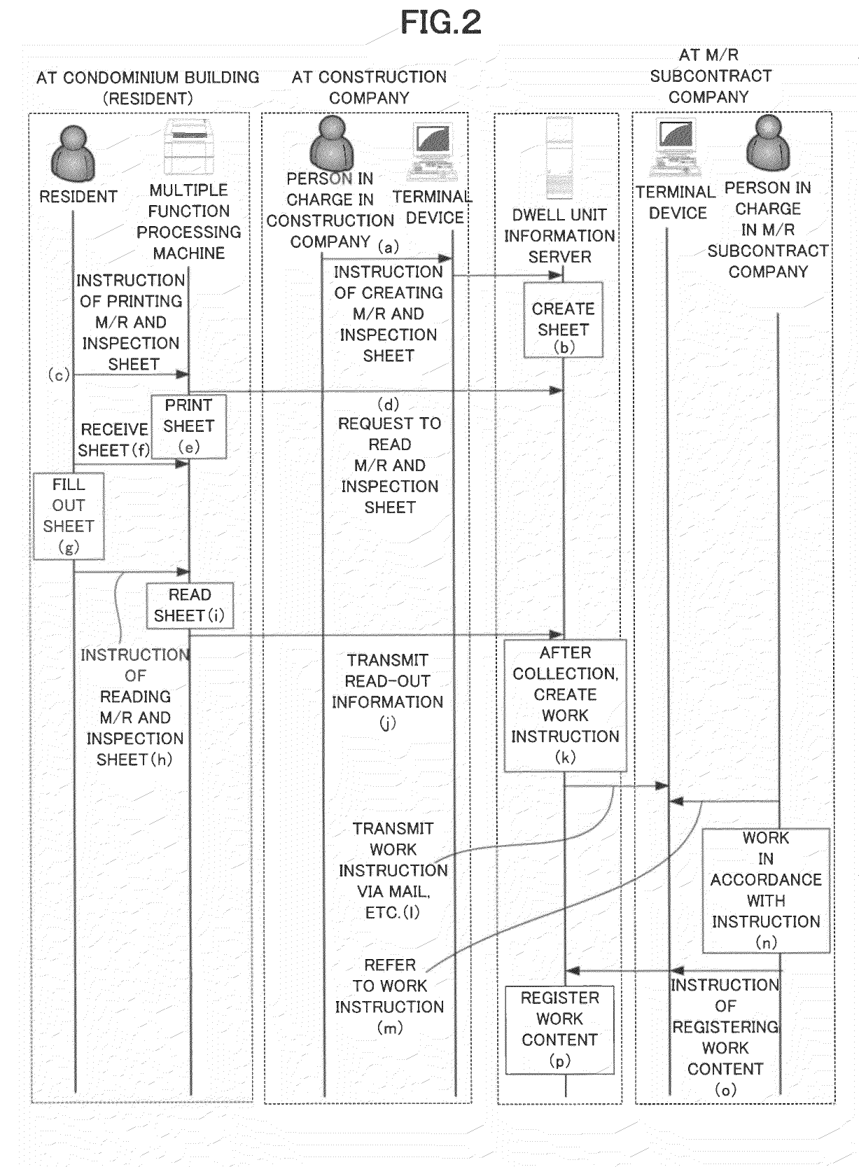

First, with reference to FIG. 2, an explanation will be given of a workflow of a periodical maintenance/repair inspection work of a condominium building using the dwell-unit-management supporting system 10 having the foregoing structure. The dwell-unit-management supporting system 10 is used by a construction company of the condominium building, a maintenance/repair subcontract company, and a resident of the building.

First, a person in charge of the construction company operates, for example, a terminal device provided at the company, and accesses the dwell unit information server 1 via the network 5. As the person in charge inputs an instruction of automatically creating a maintenance/repair inspection sheet to the terminal device (step a), the instruction is transmitted to the dwell unit information server 1. The dwell unit information server 1 creates document composition information on an inspection sheet in accordance with the instruction (step b). An inspection sheet is a piece of paper allowing a resident to fill out a defective part which needs maintenance/repair or inspection. Examples of the file format of the inspection sheet are an HTML file and a PDF file. The document composition information on the inspection sheet includes information on the appearance of a document needed in displaying and printing the document, such as a font of a character, a size thereof, and a paragraph indent, i.e., format information, in addition to text information and image information. The document composition information on the inspection sheet is created for each designated dwell unit.

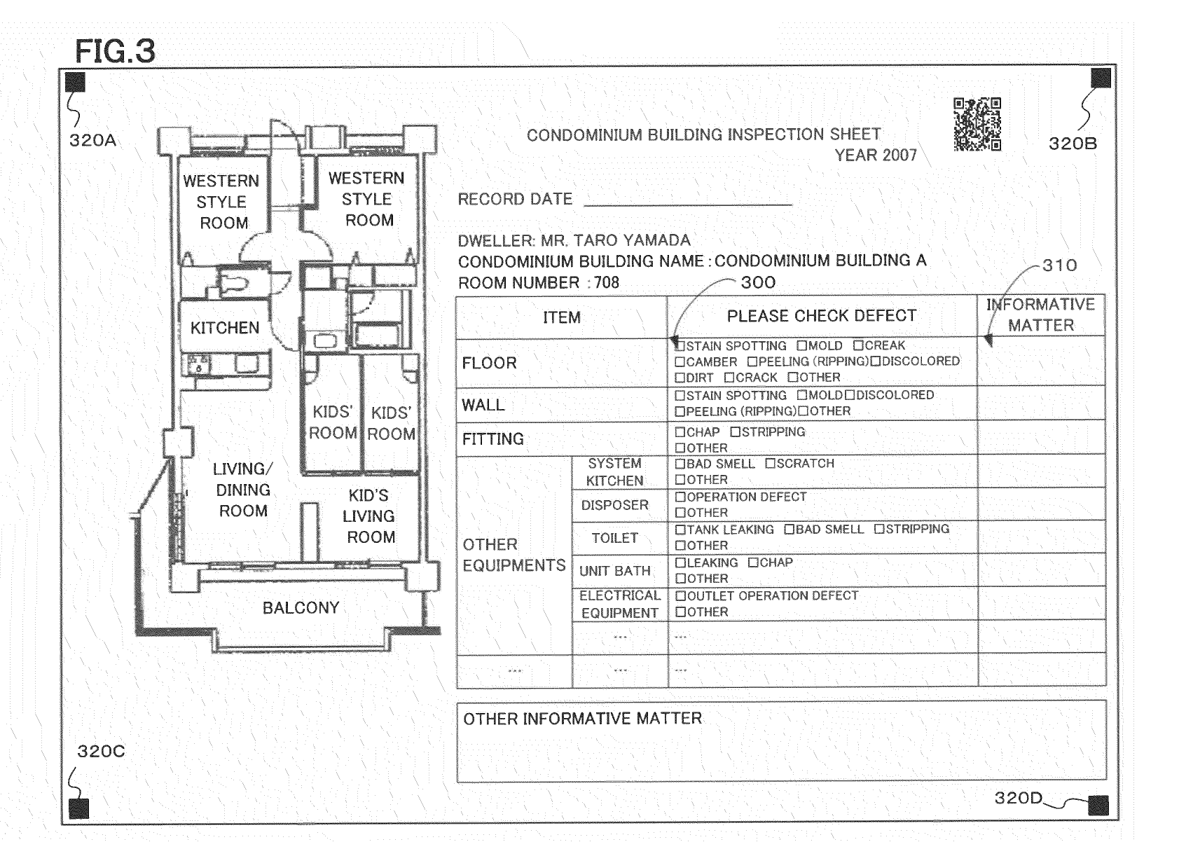

FIG. 3 shows an example of the inspection sheet. In the inspection sheet, for example, a floor plan of a dwell unit subjected to maintenance/repair or inspection and inspection lists of the dwell unit are displayed. The floor plan of the dwell unit is displayed at a predetermined first position (left side in FIG. 3) in the inspection sheet, and the inspection lists are displayed at a predetermined second position (right side in FIG. 3) in the inspection sheet. It is preferable that the floor plan should have a coloration of highlight colors or elementary colors from the standpoint that it is subjected to an image processing to be discussed later. The inspection lists enable filling of the content of a failure in detail in accordance with the equipments of a dwell unit type.

As the document composition information on the inspection sheet is created (step b), a resident of a condominium building operates, for example, a shared multiple function processing machine 2 provided at the building, and makes an instruction to print out the automatically-created inspection sheet for the dwell unit where the resident resides (step c). The multiple function processing machine 2 transmits a reading request of the document composition information on the inspection sheet to the dwell unit information server 1, and acquires the document composition information from the dwell unit information server 1 (step d). The multiple function processing machine 2 creates bitmap data based on the acquired document composition information, and prints out an image corresponding to the bitmap data as the inspection sheet (step e). The resident of the condominium building receives the print-out inspection sheet (step f), and fills out a portion which needs maintenance/repair, and the content of a failure in the inspection sheet in handwriting (step g).

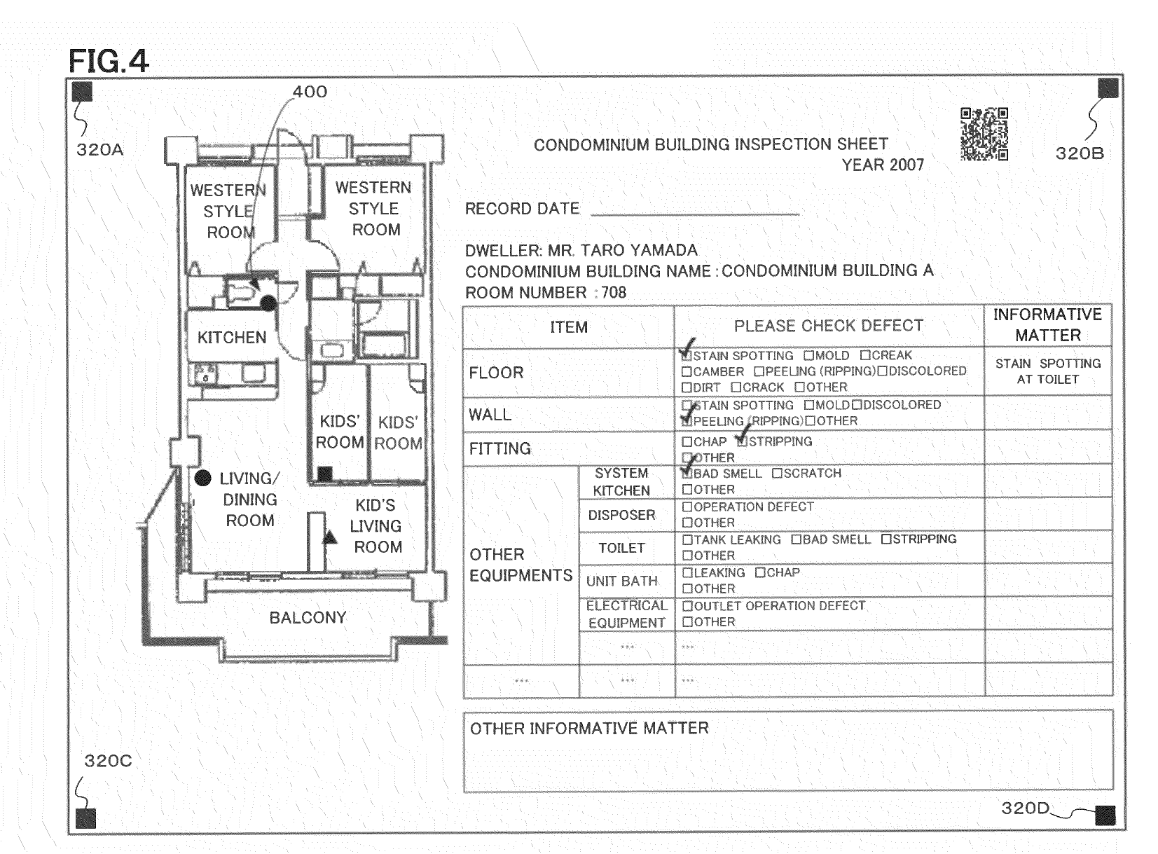

For example, as shown in FIG. 4, the resident fills a mark, such as a black circle mark, a triangle mark, or a square mark at a position corresponding to a defective part in the floor plan in the inspection sheet. In the embodiment, for example, when a floor (wooden floor) is defective, the resident fills a circle mark at a corresponding position in the floor plan. When a wall (wall paper) is defective, the resident fills a triangle mark at a corresponding position in the floor plan. Furthermore, when a fitting is defective, the resident fills a square mark at a corresponding position in the floor plan. Note that the individual marks may indicate failures of equipments other than the foregoing floor, wall, and fitting.

Further, the resident fills the detail of the failure in the inspection lists in handwriting. Using both marking and inspection list makes it possible to specify which part has a failure and what failure is present in the equipments disposed over a wide range like the floor.

It is preferable that filling of the inspection sheet should be carried out using a ballpoint pen with a predetermined color (e.g., black) for the purpose of the image processing to be discussed later. When finishing the filling of the inspection sheet, the resident instructs the multiple function processing machine 2 to read the inspection sheet (step h). In accordance with the instruction, the multiple function processing machine 2 reads the inspection sheet (step i).

In the meantime, a QR code (two-dimensional code) as code information is displayed at a predetermined third position (upper right corner in FIG. 3) in the inspection sheet. This will be explained in detail in an explanation for a “inspection sheet creation process” to be discussed later, but the code information includes information to specify that the printed material is printed using what document composition information, i.e., document identification information for identifying the type of a document. Note that a code other than a QR code may be used as code information. The multiple function processing machine 2 performs various processes on the read-out image, analyses the code information, and transmits the processed image and the analyzed code information (including document identification information) to the dwell unit information server 1 (step j).

Based on the received document identification information, the dwell unit information server 1 activates a program which processes the read-out information transmitted from the multiple function processing machine 2 (step k). More specifically, when the document identification information specifies that a document is an inspection sheet, the dwell unit information server 1 collects the inspection sheets, and activates a program of creating a work instruction for each maintenance/repair subcontract company responsible for an equipment needing an inspection. The dwell unit information server 1 starts a process of creating a work instruction in accordance with such a program.

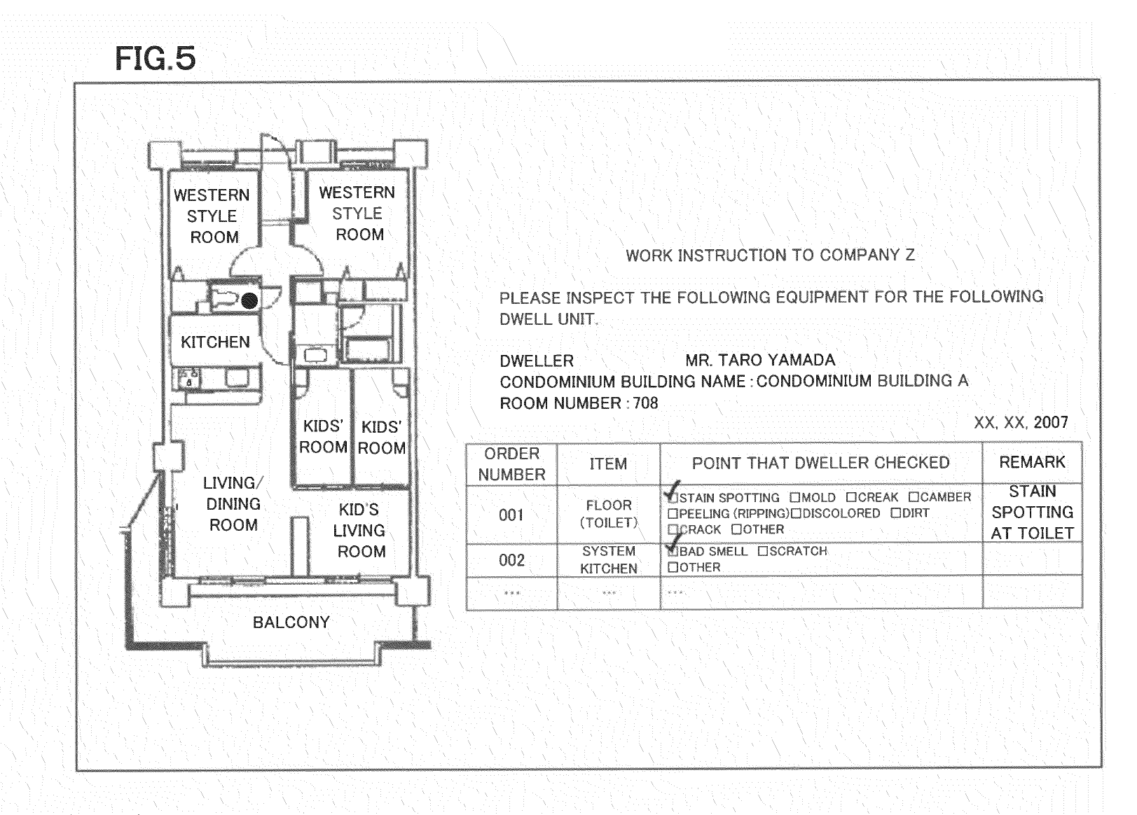

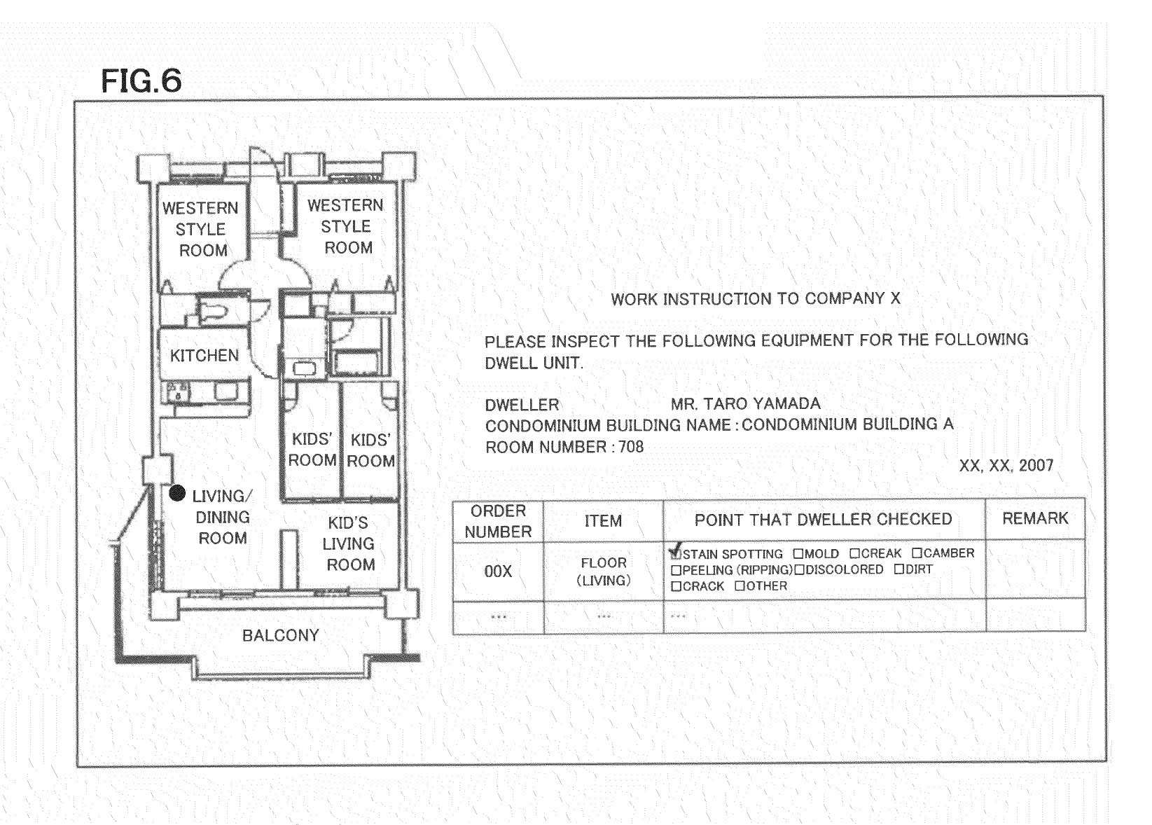

FIGS. 5 and 6 show examples of work instructions to companies responsible for maintaining/repairing a toilet. The dwell unit information server 1 attaches a created work instruction to a mail as an attached file, and automatically transmits the mail to the mail server of a maintenance/repair subcontract company (step l). A person in charge in the maintenance/repair subcontract company operates a terminal device connected to the network 5, and browses the transmitted work instruction (step m). The person in charge in the maintenance/repair subcontract company carries out a maintenance/repair work in accordance with the work instruction (step n). When the work is completed, the person in charge in the maintenance/repair subcontract company inputs the content of the work from the terminal device, and instructs the dwell unit information server 1 to register the input work content (step o). The dwell unit information server 1 registers the work content in accordance with the instruction (step p). Thereafter, the dwell unit information server 1 provides information on the registered work content to a resident of the condominium building and the construction company in response to a request therefrom.

Next, explanations will be given of the respective structures of the dwell unit information server 1 and the multiple function processing machine 2 to realize the flow in FIG. 2.

(Dwell Unit Information Server 1)

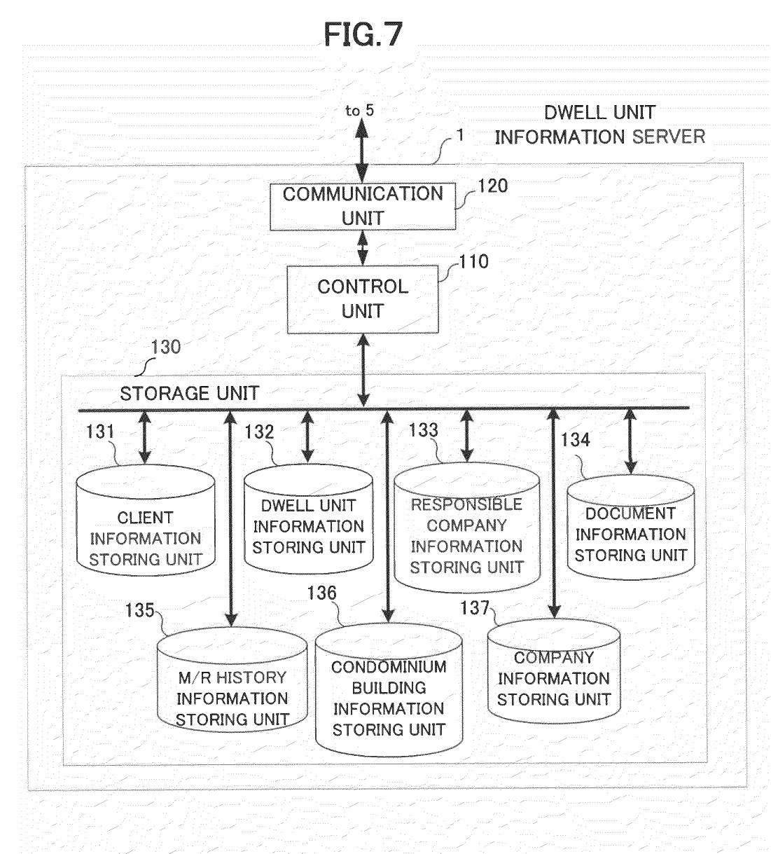

FIG. 7 is a block diagram showing the general structure of the dwell unit information server 1. The dwell unit information server 1 has a control unit 110, a communication unit 120, and a storage unit 130. Such structural components will be explained below individually.

The control unit 110 has a CPU (Central Processing Unit) (not shown), a ROM (Read Only Memory) (not shown), a RAM (Random Access memory) (not shown), and the like. The CPU executes a control when the dwell unit information server 1 is activated by executing an activation program stored in the ROM. Moreover, the CPU transmits various information to the multiple function processing machine 2 in response to a request from the multiple function processing machine 2 by executing programs stored in the storage unit 130 to be discussed later. The RAM is used as an area which temporarily stores various data when the CPU executes a program. Note that a program stored in the storage unit 130 may be stored in the RAM and then executed.

The communication unit 120 has a communication interface, and communicates with the multiple function processing machine 2 to be discussed later and a terminal device via the network 5. The communication unit 120 transmits/receives data with such devices in accordance with a protocol like TCP/IP. The communication unit 120 may include a modem device or a infrared communication device or the like. The communication unit 120 has a function of serving as a receiving unit that receives information read out by the multiple function processing machine 2 from the multiple function processing machine 2, and has a function of serving as a process unit that executes various dwell-unit-management processes together with the control unit 110.

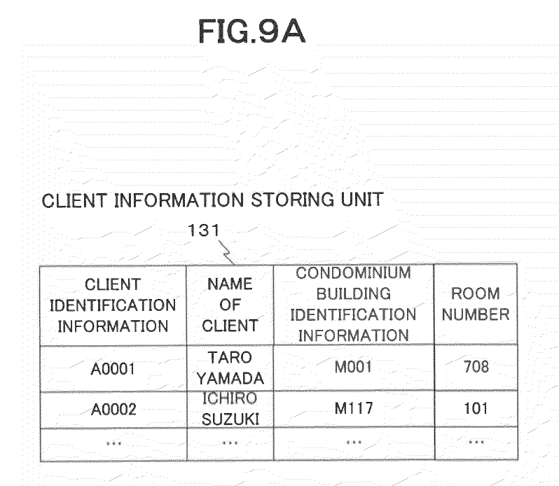

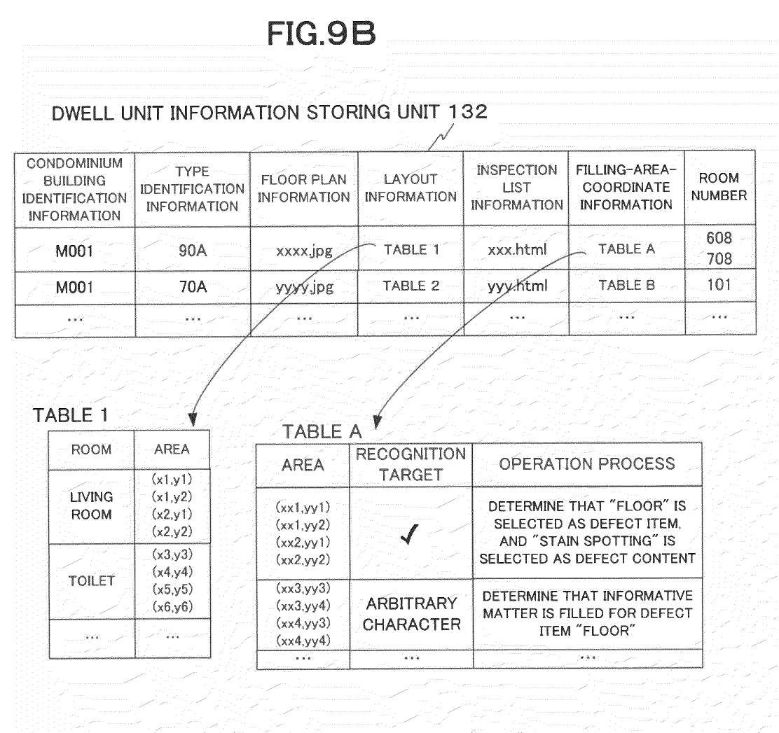

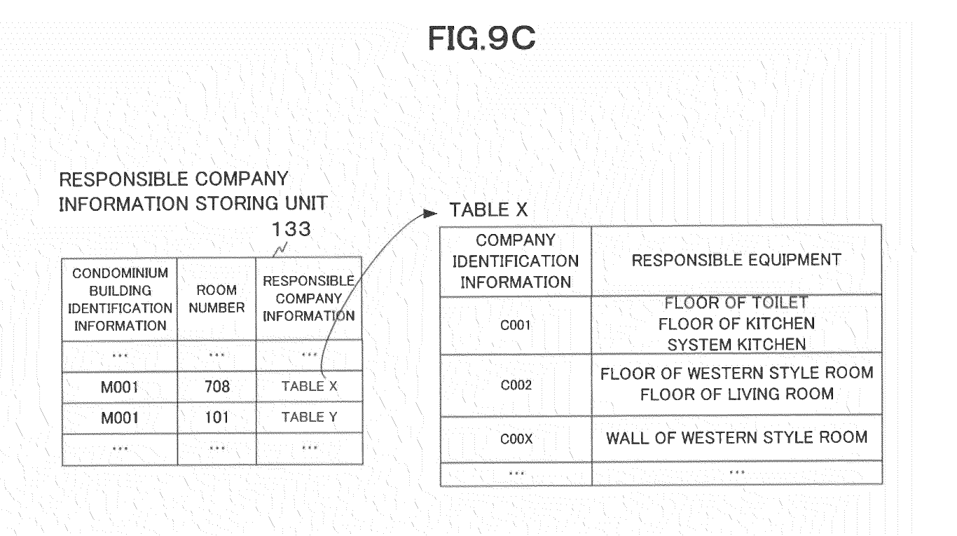

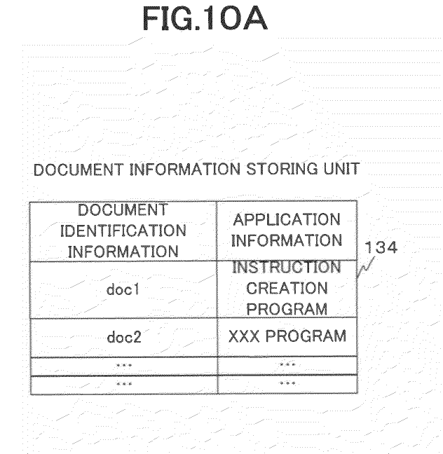

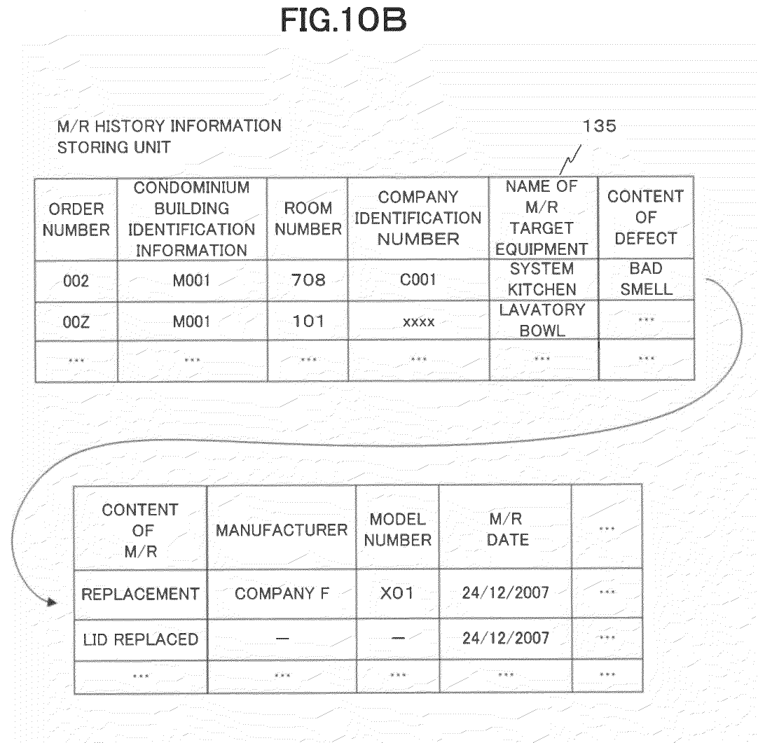

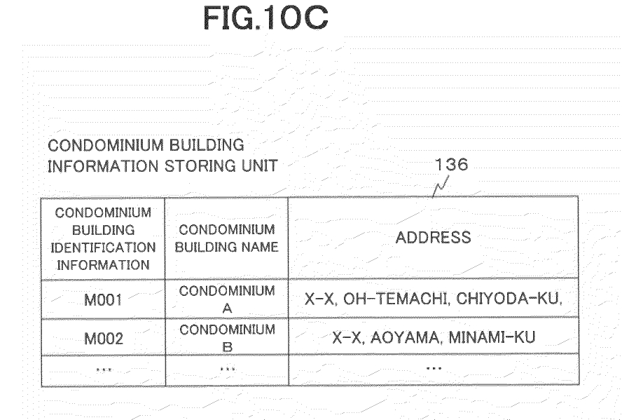

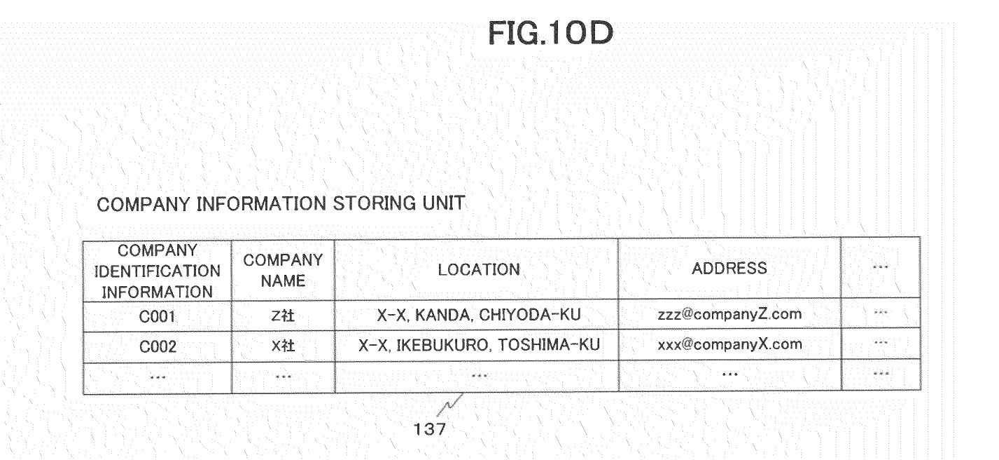

The storage unit 130 comprises, for example, a large-capacity hard disk drive. The storage unit 130 stores control programs including an operating system controlling the dwell unit information server 1 entirely and the peripheral devices thereof, a web application program providing dwell unit information to be discussed later, and the like. The storage unit 130 functions as a client information storing unit 131, a dwell unit information storing unit 132, a responsible company information storing unit 133, a document information storing unit 134, a maintenance/repair history information storing unit 135, condominium building information storing unit 136, a company information storing unit 137, and the like. The structural examples of individual storing units 131 to 137 will be explained with reference to FIGS. 9A to 9C and 10A to 10D.

As shown in FIG. 9A, the client information storing unit 131 stores information on a client who purchased a dwelling unit of a condominium building. More specifically, in the client information storing unit 131, client identification information for specifying the client, the name of the client, a condominium building identification information for specifying the condominium building purchased by the client, and the room number of the condominium building purchased by the client are stored in association with each other. Hereinafter, an explanation will be given that a purchaser of a dwell unit of a condominium building is the resident of the dwell unit in the embodiment.

The dwell unit information storing unit 132 shown in FIG. 9B stores information on a dwell unit type of a condominium building. Each of condominium buildings has some different types of dwell units, and each dwell unit has individual floor plan and equipment in accordance with the type thereof. In the dwell unit information storing unit 132, condominium building identification information for identifying a condominium building, type identification information for specifying a dwell unit type, floor plan information specific to each dwell unit type of the condominium building, layout information, inspection list information, filling-area-coordinate information, and dwell unit information like a room number having the dwell unit type are stored in association with each other. If the dwell unit information storing unit 132 is searched with the condominium building identification information and the type identification information for specifying a dwell unit type being used as main keys, it is possible to obtain dwell unit information on the dwell unit.

The floor plan information is a pointer to an image file of a floor plan (like a floor plan shown in the left side of FIG. 3) which indicates the floor plan of a dwell unit specified by the condominium building identification information and the dwell unit type identification information. Note that the file format of the image file is JPEG in FIG. 9B, but the file format is arbitrary. The layout information is a pointer to a table indicating the layout of each room in the floor plan. The table indicated by the layout information is present floor plan by floor plan, and positional coordinates of each room indicated in the floor plan are specified in the table.

The inspection list information is a pointer of, for example, an electronic file including document composition information shown in the right side of FIG. 3. The inspection list information constitutes a part of document composition information for an inspection sheet for a dwell unit. A list of inspection items and inspection contents in the corresponding dwell unit is stored in a file specified by the inspection list information. In regard to the inspection items, there is no big difference among dwell units. Accordingly, some of inspection list information are prepared beforehand, and one which is most appropriate to the corresponding dwell unit can be selected. Although the file format of the document composition information file indicated by the inspection list information is HTML, the file format is arbitrary as far as such a file format can define document composition information.

The filling-area-coordinate information is a pointer to a table that stores information on positional coordinates of an area in an inspection sheet where a user can fill out a mark or the like. As represented by the step k in FIG. 2, as the dwell unit information server 1 receives read-out information on an inspection sheet filled by the dweller (in the inspection sheet, information defined by the inspection list information is written) from the multiple function processing machine 2, automatically collects the read-out information. When automatically collecting the read-out information, information indicating what is filled and where it is filled in a read-out inspection sheet becomes necessary. Such information is stored in a table indicated by the filling-area-coordinate information. Because areas in which information is filled out differ depending on inspection sheets, a table indicated by the filling-area-coordinate information is present for each inspection list information.

A table indicated by the filling-area-coordinate information stores coordinate values indicating an area which allows a user to fill out a mark or the like on an inspection list, a “recognition target”, and an “operating process” in association with one another. In the “recognition target”, information on a mark or character to be written in the area where a user can fill out those is stored. Moreover, in the “operating process”, a process of the dwell unit information server 1 is stored. That is, by referring to a table indicated by a filling-area-coordinate information, it is possible to specify a process of the dwell unit information server 1 to be executed when a specific recognition target is detected in a specific area in an inspection sheet.

Note that coordinate information of an area over a floor plan corresponding to each room (coordinates of an area of each room in a table indicated by layout information) and coordinate information of an area which can be filled on an inspection list (coordinates of an area which can be filled in a table indicated by filling-area-coordinate information) are defined on the basis of a case where an inspection sheet is printed out with a predetermined size. Accordingly, even if an inspection sheet is scaled and printed, by scaling the read-out information in accordance with the scaling ratio, coordinates of each area in the read-out area can match coordinates of each area defined by coordinate information.

The responsible company information storing unit 133 stores an equipment of each room in a condominium building and a maintenance/repair company in association with each other. Equipments may be changed depending on the preference of a purchaser even if the dwell units are the same type. Accordingly, by storing a correspondence relationship between an equipment and a maintenance/repair company for each room in the condominium building, it is possible to specifically cope with the condition of each room. For example, as shown in FIG. 9C, the responsible company information storing unit 133 stores condominium building identification information for specifying a condominium building, a room number, and responsible company information for a dwell unit specified by the condominium building identification information and the room number, in association with one another. The responsible company information is a pointer indicating a table that associates the equipment of a dwell unit with maintenance/repair company identification information for specifying a maintenance/repair company which is in charge for maintenance/repair of that equipment. By referring to the responsible company information storing unit 133 with the condominium building identification information and a room number being as main keys, a pointer (maintenance/repair company) of a table can be obtained.

For example, according to the responsible company information storing unit 133 shown in FIG. 9C, information on a company which is in charge for each equipment in the room 708 in a condominium building specified by condominium building information M001 is stored in a table X. The table X is thus referred. By referring to the table X, a relationship between company identification information for specifying a maintenance/repair company and an equipment that the maintenance/repair company is responsible to do maintenance/repair in the room 708 becomes clear.

The document information storing unit 134 shown in FIG. 10A stores document identification information for specifying the kind of document composition information created by the dwell unit information server 1, and information for specifying an application for processing read-out information when the read-out information specified by the document identification information is transmitted from the multiple function processing machine 2 to the dwell unit information server 1, in association with each other. For example, according to the document information storing unit 134 shown in FIG. 10A, an application corresponding to document identification information “doc1” for specifying document composition information for an inspection sheet is an “instruction creation program”.

The maintenance/repair history information storing unit 135 shown in FIG. 10B stores the maintenance/repair history of each equipment of a dwell unit. In the embodiment, as the maintenance/repair history of each equipment, an order number, condominium building identification information for specifying a condominium building, a room number for specifying a dwell unit having an equipment subjected to maintenance/repair, a name of the maintenance/repair target equipment, company identification information for specifying a company which is in charge to maintenance/repair of the equipment to be maintained/repaired, the content of maintenance/repair, and maintenance/repair information, such as a manufacturer when the maintenance/repair target equipment is replaced, a model number, and a maintenance/repair date, in association with one another. The order number is identification information for specifying a work instruction issued to a maintenance/repair subcontract company from a construction company. By referring the maintenance/repair history information storing unit 135 with the order number being as a main key, various kinds of maintenance/repair histories can be obtained.

As shown in FIG. 10C, the condominium building information storing unit 136 stores information on a condominium building to be managed by the dwell-unit-management supporting system 10. Examples of such information to be stored are condominium building identification information for specifying a condominium building, the name of the condominium building, and the address of the condominium building. Those pieces of information are stored in association with one another.

The company information storing unit 137 shown in FIG. 10D, stores information on a subcontract company which is in charge to do maintenance/repair of a condominium building. Examples of such information are company identification information for specifying a maintenance/repair subcontract company, the name of the subcontract company, the address, the mail address of a person in charge in the subcontract company. Those pieces of information are stored in association with one another.

It is necessary that the client information storing unit 131, the dwell unit information storing unit 132, the responsible company information storing unit 133, the document information storing unit 134, the condominium building information storing unit 136 and the company information storing unit 137 store information beforehand. Conversely, in regard to information stored in the maintenance/repair history information storing unit 135, a part of such information is stored by the dwell unit information server 1 when a work instruction is created, and the remaining is stored by the subcontract company when a maintenance/repair work is completed.

(Structure of Multiple Function Processing Machine)

Next, an explanation will be given of the structure of the multiple function processing machine 2 shown in FIG. 1. The multiple function processing machine 2 acquires information from the dwell unit information server 1, displays the acquired information on an operation panel, prints the acquired information, and, scans an image printed on a piece of paper, and transmits information on the scanned image to the dwell unit information server 1.

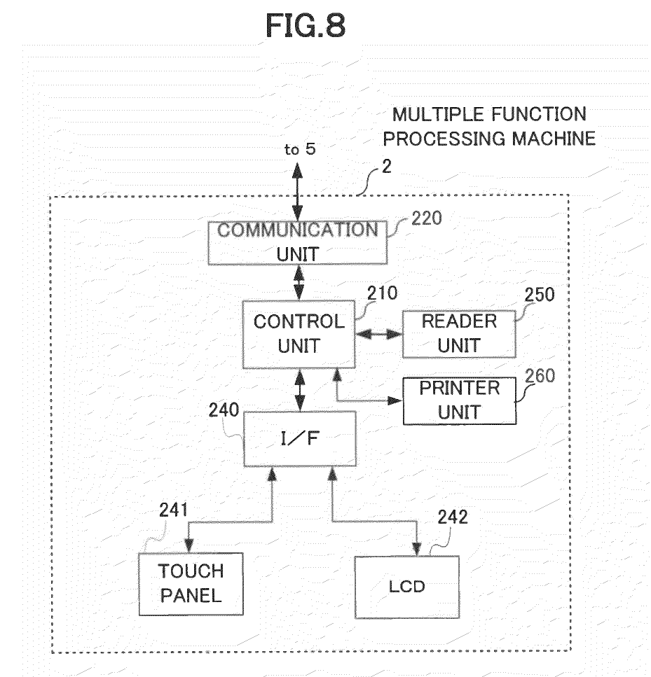

FIG. 8 shows the general structure of the multiple function processing machine 2. As shown in FIG. 8, the multiple function processing machine 2 has a control unit 210, a communication unit 220, an interface (I/F) 240, a touch panel 241, an LCD (Liquid Crystal Display) 242, a reader unit 250, and a printer unit 260. Those structural components will be explained individually below.

The control unit 210 has a CPU (Central Processing Unit) (not shown), a ROM (Read Only Memory) (not shown), a RAM (Random Access Memory) (not shown), and the like. The control unit 210 controls the whole multiple function processing machine 2. As the CPU executes a control program stored in the ROM, various controls and computation processes are executed. Together with execution of such controls and computation processes, the CPU temporarily stores various kinds of data in the RAM and uses the RAM as a work area. The control unit 210 has a function of serving as, for example, a read-out information analyzing unit which analyses read-out information.

The communication unit 220 has a communication interface or the like. The communication unit 220 transmits/receives information in accordance with a protocol like TCP/IP. The communication unit 220 may have a modem device, an infrared communication device, and the like. The communication unit 220 transmits/receives various pieces of information with the dwell unit information server 1 via the network 5. The communication unit 220 has a function of serving as an information transmitting unit that performs a predetermined image processing on read-out image information, and transmits the processing result to the dwell unit information server 1.

The I/F 240 has an interface function with an output device like the LCD 242. The I/F 240 displays images corresponding to image information for allowing a user to input an instruction and various information transmitted from the dwell unit information server 1 on the LCD 242. The I/F 240 also has an interface function with an input device like the touch panel 241 provided over the LCD 242. As an operation like the hand of a user touches a predetermined portion of the touch panel 241 is carried out, information corresponding to such an operation is input to the multiple function processing machine 2. In addition, the I/F 240 may further have an interface function with input devices, such as a keyboard and a mouse, and may receive operational inputting using those devices.

The reader unit 250 is a scanner device that reads a document, a drawing, a picture on a piece of paper, and acquires image information (digital image data) corresponding thereto.

The printer unit 260 is an output device that prints an image on a piece of paper. The multiple function processing machine 2 has a function of printing an image corresponding to image data transmitted from a terminal device (not shown) connected to the network 5. Further, the multiple function processing machine 2 can print an image corresponding to an electronic file specified by an operational inputting from an input device like the touch panel 241.

Next, an explanation will be given of a process executed by the dwell unit information server 1 and the multiple function processing machine 2 which have the foregoing structures to realize the flow shown in FIG. 2. The dwell unit information server 1 is in a state where the dwell unit information server 1 can provide a web application program for dwell unit management including necessary processes for maintenance and repair to a terminal device accessing thereto via the network 5. A web browser is installed in the terminal device (not shown) of a user (construction company, a condominium building resident, maintenance/repair subcontract company, etc.). As the user operates the terminal device and accesses the dwell unit information server 1 via the network 5, first, a user authentication process is executed. When the user authentication is succeeded, the user becomes able to use various functions provided by the web application program.

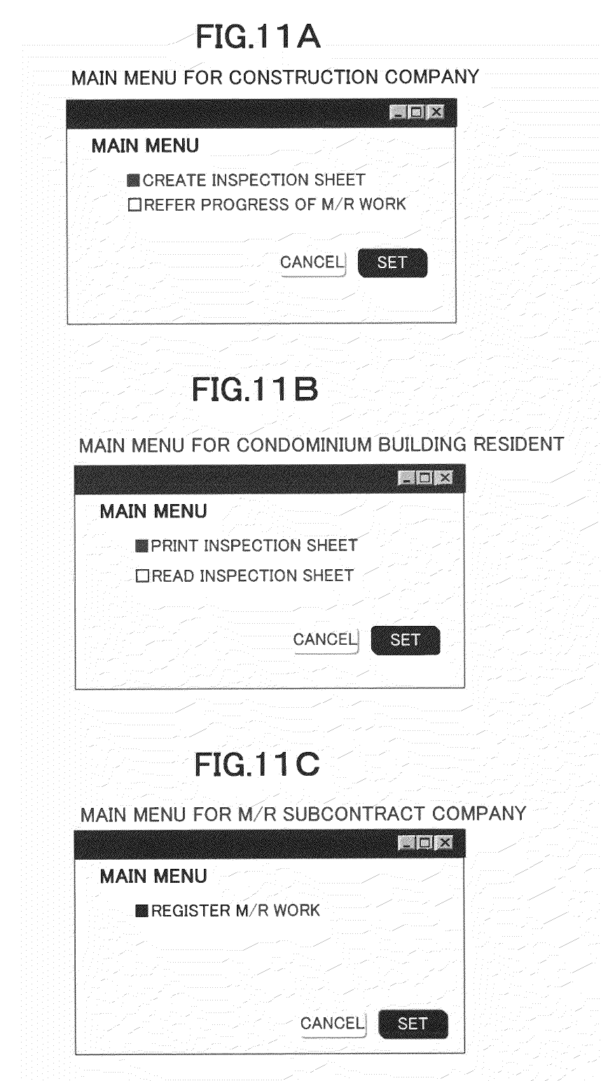

More specifically, in the user authentication process, the user accesses a URL (Uniform Resource Locator) of the dwell unit information server 1 for dwell unit management, and inputs login information, such as a user ID and a password. The dwell unit information server 1 checks whether the user ID and the password match a user ID and a password registered beforehand. When the user ID and the password match, the user is authorized, and the dwell unit information server 1 transmits information for displaying menu screens shown in FIGS. 11A to 11C to the terminal device of the user. Note that the dwell unit information server 1 distinguishes the construction company, the condominium building resident, and the maintenance/repair subcontract company from one another based on, for example, login information, and depending on the user, creates menu screen information for the construction company (FIG. 11A), for the condominium building resident (FIG. 11B), and for the maintenance/repair subcontract company (FIG. 11C). The terminal device displays a menu screen on the basis of the received menu screen information. The user operates the terminal device while viewing the menu screen, and selects a function (menu) that the user desires to use.

Thereafter, when the user accesses a predetermined home page of the dwell unit management application provided by the dwell unit information server 1 from the terminal device, the control unit 110 of the dwell unit information server 1 transmits screen information of the home page to the accessing terminal device through the same foregoing procedures. At the terminal device, when a screen on the basis of the received screen information is displayed, the user operates an input device like a keyboard to input predetermined information in accordance with displayed information. As the user presses a send button or a set button which is a trigger for a transmission process, the input content (input information) is transmitted to the dwell unit information server 1. The dwell unit information server 1 executes a predetermined process in accordance with the received input information.

The multiple function processing machine 2 can execute a program that realizes a function of reading and printing information owned by the dwell unit information server 1, and a function of reading information written on a piece of paper like an inspection sheet, and transmitting the read-out information to the dwell unit information server 1 when it is recognized that code information is included in the read-out information. The functions provided by the multiple function processing machine 2 can be selected by operating the touch panel 241.

The multiple function processing machine 2 further has, for example, a non-contact type card reader. As the user holds an IC card, storing information (e.g., the same information as the client identification information) for specifying the user, over the card reader, the multiple function processing machine 2 transmits the information for identifying the user to the dwell unit information server 1, and checks whether or not the user can use the functions of the multiple function processing machine 2. As the authentication is succeeded by the dwell unit information server 1, the user becomes able to use the functions of the multiple function processing machine 2. When the authentication is succeeded, the dwell unit information server 1 stores the user ID used for the authentication and information for specifying a multiple function processing machine that inquires the authentication, in association with each other. The associated information are discarded when the user logs out or when there is a time-up since the multiple function processing machine 2 is not operated for a predetermined time.

(Automatic Creation of Inspection Sheet)

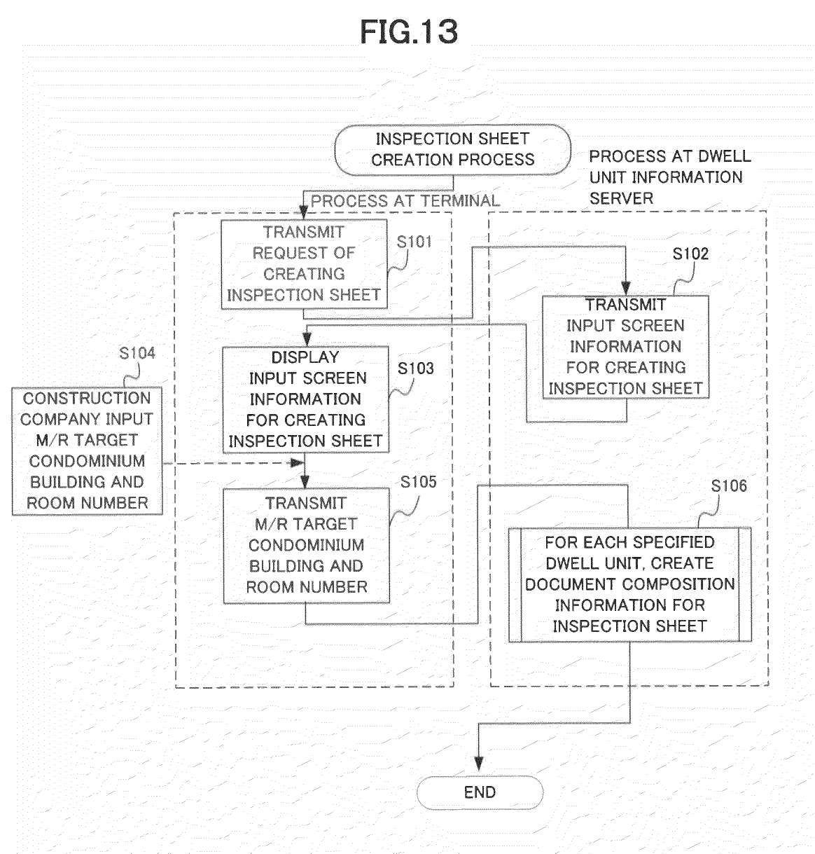

The flow of an automatic creation process of an inspection sheet will be explained with reference to FIG. 13. First, as a “creation of inspection sheet” button is selected from the menu screen shown in FIG. 11A and displayed by the browser of the terminal device by the operational inputting of a person in charge in the construction company, the creation process of an inspection sheet shown in FIG. 13 is started. First, a request of “creating an inspection sheet” is transmitted to the dwell unit information server 1 (step S101). As the dwell unit information server 1 receives the request through the communication unit 120, the control unit 110 transmits input screen information (not shown) for allowing the user to input necessary information to create an inspection sheet to the terminal device (step S102). The terminal device displays the received input screen information (step S103). The person in charge in the construction company inputs, for example, the name of a condominium building subjected to maintenance/repair, and a room number (plural room numbers may be specified) in accordance with the screen information, and presses a send button (step S104). As the send button is pressed, the terminal device transmits the input information to the dwell unit information server 1 (step S105).

As the control unit 110 of the dwell unit information server 1 receives the condominium building name subjected to maintenance/repair and the room number, the control unit 110 creates document composition information for an inspection sheet shown in FIG. 3 for a dwell unit specified by the received information (step S106). When plural dwell units are specified, the document composition information for an inspection sheet is created for each dwell unit.

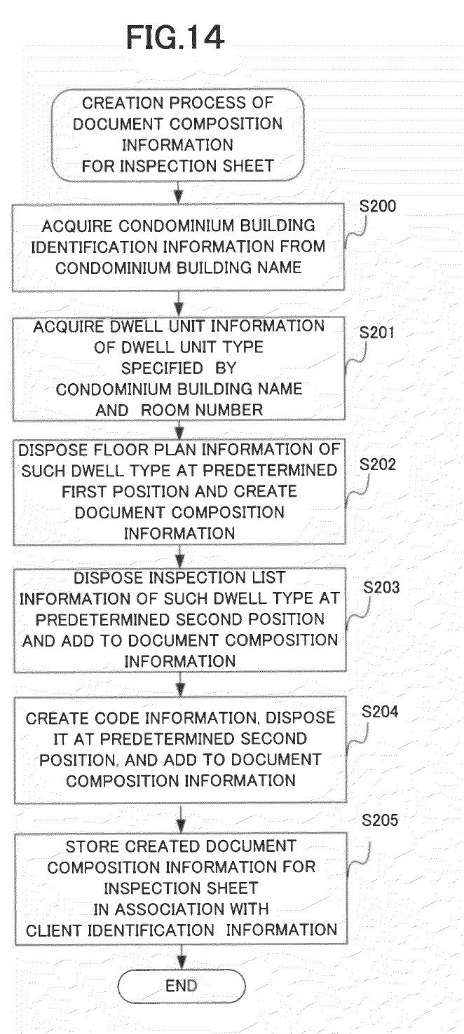

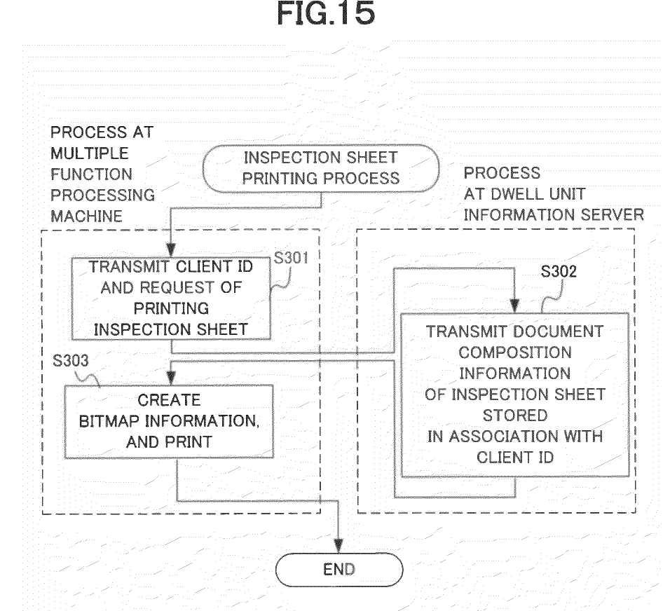

FIG. 14 shows a process of creating the document composition information for an inspection sheet. The control unit 110 refers to the condominium building information storing unit 136, and acquires condominium building identification information having the received condominium building name (step S200). Next, the control unit 110 acquires records specified by the acquired condominium building identification information and the received room number (i.e., information on a dwell unit type, such as type identification information, floor plan information, layout information, inspection list information and filling-area-coordinate information) from the dwell unit information storing unit 132 (step S201).

The control unit 110 creates document composition information in such a way that a floor plan image on the basis of floor plan information included in the acquired records is disposed at the predetermined first position (left side in FIG. 3) over the inspection sheet for the dwell unit (step S202).

Moreover, the control unit 110 adds information to the document composition information in such a way that inspection lists on the basis of inspection list information included in the acquired records is disposed at the predetermined second position (right side in FIG. 3) over the inspection sheet for the dwell unit (step S203).

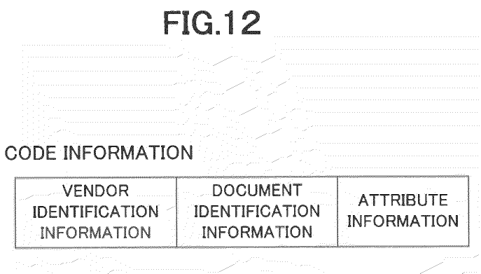

Furthermore, the control unit 110 creates code information, and adds information to the document composition information in such a way that an image corresponding to the code information is disposed at the predetermined third position (upper right corner in FIG. 3) of the inspection sheet (step S204). As shown in FIG. 12, the code information includes vendor identification information, document identification information, and attribute information.

The vendor identification information is for specifying a company which manages the dwell unit information server 1. The vendor identification information is given so that the dwell unit information server 1 does not falsely operate by receiving code information provided by another company.

The document identification information is for identifying a kind of the document composition information for an inspection sheet. In the example shown in FIG. 10A, “doc1” is given as the document identification information.

The attribute information indicates the attribute of an inspection sheet which is to be recorded on a piece of paper that the code information is given. For example, in order to specify for what dwell unit an inspection sheet is created, condominium building identification information and a room number are given as the attribute information of the inspection sheet.

The client identification information can be acquired by searching the client information storing unit 131 with the condominium building identification information acquired at the step S200 and the room number of a dwell unit subjected to the process currently being as search keys. Vendor identification information for specifying the document management server 1 and document identification information for specifying each document composition information are stored in the storage unit 130 beforehand.

When creation of document composition information for an inspection sheet corresponding to the specified dwell unit is completed, the control unit 110 stores the document composition information in the storage unit 130 in association with the client identification information acquired when the code information is created (step S205). When creation of document composition information for inspection sheets in regard to all dwell units transmitted at the step S105 is completed, the automatic creation process of the inspection sheets is completed.

Next, an explanation will be given of a process executed by a resident of a condominium building who operates the multiple function processing machine 2 provided at the condominium building. As explained above, in order to use the multiple function processing machine 2, it is necessary for the resident of the condominium building to perform user authentication using an IC card or the like. As an authentication process is succeeded, the control unit 110 of the dwell unit information server 1 stores a user ID used for the user authentication in association with a multiple function processing machine 2 which has requested the user authentication. Accordingly, after this stage, when any request is transmitted from the multiple function processing machine 2 to the dwell unit information server 1, identification information for identifying the multiple function processing machine 2 will be transmitted together. This makes it possible for the dwell unit information server 1 to specify that from which user a request is made.

(Printing Process of Inspection Sheet)

Next, an explanation will be given of a process that a resident of the condominium building prints an inspection sheet created for his/her own dwell unit using the multiple function processing machine 2, with reference to FIG. 15. As the resident of the condominium building operates the touch panel 241 of the multiple function processing machine 2 and selects the inspection sheet print function, a printing process of an inspection sheet is started. First, the multiple function processing machine 2 transmits a request for reading out document composition information for an inspection sheet to the dwell unit information server 1 together with information for specifying the multiple function processing machine 2 (step S301). The control unit 110 of the dwell unit information server 1 reads out document composition information for an inspection sheet stored in association with client identification information which is the same as a user ID for specifying the user from the storage unit 130. Thereafter, the control unit 110 transmits the read-out information to the multiple function processing machine 2 which has made a request (step S302). The multiple function processing machine 2 creates bitmap data based on the received document composition information for an inspection sheet, and prints an image corresponding to the bitmap data (step S303).

As explained with reference to the flow in FIG. 2, the resident fills out an item that the resident wants inspection using a pen of a predetermined color (e.g., black) in the printed inspection sheet (see, for example, FIG. 4). The user instructs the multiple function processing machine 2 to read the filled-out inspection sheet so that the dwell unit information server 1 can analyze the filled-out content.

(Reading Process of Inspection Sheet)

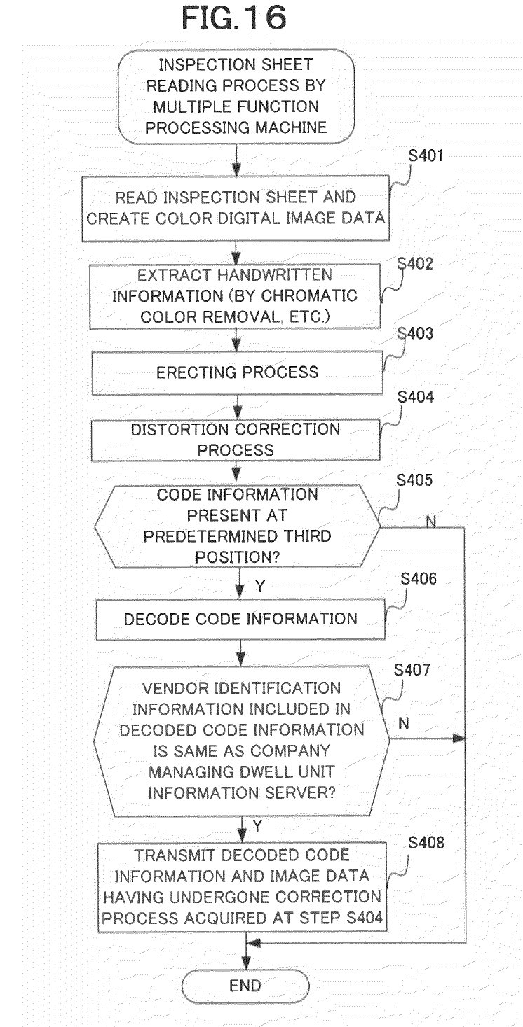

Next, a reading process of the inspection sheet by the multiple function processing machine 2 will be explained with reference to FIG. 16. A filled-out inspection sheet is set at the reader unit 250 of the multiple function processing machine 2 provided at the condominium building by the user. The touch panel 241 is operated after the inspection sheet is set, and as an inspection sheet reading function is selected, the reading process of the inspection sheet is started. First, the reader unit 250 reads the inspection sheet, and creates color digital image data (step S401).

The inspection sheet may be scaled when printed in some cases. Moreover, the inspection sheet may be distorted when printed or read in some cases. Therefore, the multiple function processing machine 2 executes an erecting process and a distortion correction process as preparation processes before determining whether or not the read image data includes code information.

First, as the preparation for the erecting process, the control unit 210 extracts handwritten information using a well-known scheme (step S402). Extraction of handwritten information is carried out by, for example, a chromatic color removing process. According to the chromatic color removing process, chromatic colors printed on a piece of paper beforehand are removed, and only a handwritten blacked part is extracted.

When a color image is represented by an RGB 24 bit image, as individual values of RGB become close to 0, it becomes a color more similar to black. Accordingly, for example, the control unit 210 sets ThB as a predetermined threshold with respect to each pixel of image data, and for a pixel which satisfies all of R<ThB, G<ThB, and B<ThB, it is determined that the color of this pixel is black. Moreover, for pixels which do not satisfy the foregoing conditions, the control unit 210 determines that the colors of such pixels are chromatic colors. Based on the result of such determination, by removing pixels which are determined as having chromatic colors, a monochrome image can be emerged.

By limiting print colors to highlight colors or natural colors, a handwritten part can be extracted using such a convenient scheme. Note that the code information is used for a process to be discussed later, it is necessary to print the code information with a black color so as not to be subjected to chromatic color removal. It is needless to say that schemes other than the chromatic color removing process can be used as a scheme of extracting handwritten information.

Subsequently, the control unit 210 performs a conventional erecting process on the extracted handwritten information (step S403). More specifically, the control unit 210 performs, for example, an OCR (Optical Character Recognition) process on the extracted handwritten information, and temporarily saves the result. Next, the control unit 210 rotates an image 90 degree by 90 degree, performs an OCR process, and temporarily saves the result. In this manner, after the OCR processes are performed in four directions, the direction of an image is specified using a certainty factor, which is a measure of the result of an OCR process. The certainty factor is a certainty of a recognized character. In the embodiment, the control unit 210 acquires an average value of the certainty factor of each character in each direction, and specifies a direction having the largest average value of the certainty factor as the direction of the image. It is needless to say that schemes other than the foregoing method can be used as the erecting process.

Next, the control unit 210 performs a conventional distortion correction process (step S404). For example, in the creation process of the inspection sheet, the control unit 210 creates document composition information in such a way that markers 320A to 320D (see FIG. 3) are disposed at predetermined positions (e.g., four corners) in the inspection sheet. Hereinafter, the markers 320A to 320D disposed at the predetermined positions are called ideal markers. Like the code information, the markers are not removed after the handwritten information is extracted. In order to do so, when the handwritten information is extracted using the chromatic color removing process, it is necessary to set the color of the marker as black so as not to be removed even if the chromatic color removing process is executed.

In the received image data, the control unit 210 acquires coordinate values of the markers at the four positions, and associates the markers at the four positions with ideal markers 320A to 320D. The control unit 210 performs affine transformation on the image data entirely in such a way that the positions of the acquired markers at the four positions match the positions of corresponding ideal markers 320A to 320D, respectively.

Subsequently, for the read color image, the control unit 210 of the multiple function processing machine 2 determines whether or not there is code information at a predetermined third position of the image data including the handwritten information acquired through the erecting process and the distortion correction process (step S405). When it is determined that there is code information (step S405: YES), the control unit 210 decodes the code information (step S406). When vendor information included in the decoded code information matches vendor identification information for specifying a company which manages the dwell unit information server 1 (step S407: Y), the control unit 210 transmits the image data including the handwritten information to the dwell unit information server 1 together with the decoded code information (i.e., vendor identification information, document identification information and attribute information including condominium building identification information and a room number) (step S408), and finishes the process.

When there is no code information (step S405: N) or when there is code information but vendor identification information does not match identification information of a vendor which manages the dwell unit information server 1 (step S407: N), the control unit 210 displays, for example a message to the effect on the touch panel 241, notifies the user that the vendor identification information does not match, and finishes the process.

The vendor identification information of a company which manages the dwell unit information server 1 may be stored in the ROM of the multiple function processing machine 2 beforehand, or the multiple function processing machine 2 may appropriately inquire the dwell unit information server 1 to acquire the vendor identification information.

(Automatic Creation of Work Instruction)

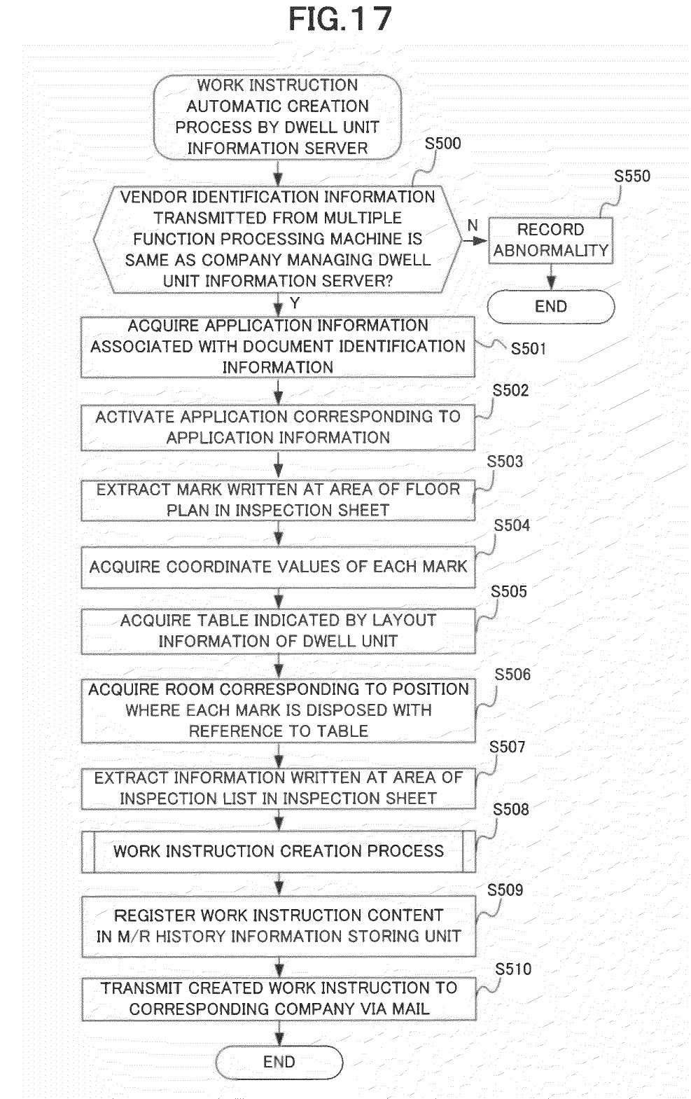

Next, an automatic creation process of a work instruction by the dwell unit information server 1 will be explained with reference to FIG. 17.

As the communication unit 120 of the dwell unit information server 1 receives the image data including the code information and the handwritten information and transmitted through the step S408, the control unit 110 determines whether or not the vendor identification information matches identification information of a vendor which manages the local dwell unit information server 1 (identification information is stored in the storage unit 130 beforehand) (step S500). When the vendor identification information matches (step S500: Y), the control unit 110 refers to the document information storing unit 134 to acquire application information associated with document identification information (step S501). Next, the control unit 110 activates an application (in this case, a work instruction creation program) corresponding to the acquired application information (step S502).

Conversely, when the vendor identification information does not match (step S500: N), the control unit 110 records that there is an error in the process in a log file or the like (step S550), and finishes the process.

Subsequently, in accordance with the work instruction creation program, the control unit 110 analyzes an area where a floor plan is disposed (predetermined first position) in the image data received from the multiple function processing machine 2, and extracts all blacked marks (circle, triangle, square, star, and the like) present in the area using a conventional scheme (step S503). Note that the control unit 110 removes any marks smaller than a predetermined size from extraction targets as noises.

For each extracted mark, the control unit 110 acquires positional information (coordinate values) of a representative point (e.g., weighted center) of a mark (step S504). Next, the control unit 110 acquires a table indicated by layout information associated with a dwell unit type specified by condominium building identification information and a room number included in the code information (attribute information) transmitted at the step S408 from the dwell unit information storing unit 132 (step S505). Further, the control unit 110 refers to the table, and acquires information on a room corresponding to an area including the representative point of a mark (step S506). Accordingly, it is possible to specify which room, which equipment the resident wants inspection, i.e., which room and which equipment are subjected to inspection that the residents desires.

For example, when writing shown in FIG. 4 with respective to the inspection sheet shown in FIG. 3 is done by Mr. “Taro Yamada” identified by client identification information A0001, the control unit 110 refers to the client information storing unit 131, and it is determined that Mr. Taro Yamada is the resident of the room 708 in condominium building having identification information M001 as shown in FIG. 9A.

Moreover, in FIG. 4, when an extracted black circle 400 is a representative point in an area surrounded by coordinates (x3, y3), (x4, y4), (x5, y5), and (x6, y6), the control unit 110 refers to layout information (i.e., table 1 shown in FIG. 9B) associated with the condominium building identification information M001 and the room number 708, and determines that the area corresponds to a “toilet”.

In the embodiment, because a black mark indicates a floor (correspondence relationship between a mark and an equipment is stored in the storage unit 130 beforehand), the control unit 110 determines that the floor in the toilet is subjected to inspection that the resident desires.

As explained above, for all extracted marks, the control unit 110 specifies in which area and in which room corresponding to that area a mark is filled. Eventually, in addition to the “floor” of the “toilet”, it is specified that the “floor” of a “living room”, “other equipments” of a “kitchen”, the “fitting” of a “kids' room ”, and the “wall” of a “kids' living room” are subjected to inspection that the resident desires.

The control unit 110 analyzes information filled in an area in image data including the received handwritten information where inspection list information is disposed (predetermined second position), and extracts information filled in the inspection lists (step S507). More specifically, the control unit 110 refers to the dwell unit information storing unit 132, and acquires a table indicated by filling-area-coordinate information of the dwell type (which can be specified on the basis of the received condominium building identification information and room number) of a target condominium building. The control unit 110 determines whether or not there is a graphic symbol, defined as a recognition target in the table, present in an area defined in the table. When determining that there is a recognition target in the area, the control unit 110 executes an operational process associated with the area in the table.

An explanation will be given of a case where, for example, an area corresponding to a check box 300 shown in FIG. 3 is an area surrounded by coordinate values (xx1, yy1), (xx1, yy2), (xx2, yy1) and (xx2, yy2), and a check mark is filled in that area as shown in FIG. 4. The control unit 110 refers to a table (in this case, table A shown in FIG. 9B) indicated by filling-area-coordinate information corresponding to a target dwell unit (i.e., condominium building identification information M001 and room number 708). In the table A shown in FIG. 9B, the “recognition target” of an area corresponding to the check box 300 is a “check mark”. Accordingly, as shown in FIG. 4, as the control unit 110 recognizes that a check mark is filled by the dweller using an arbitrary conventional marking recognition scheme, the control unit 110 determines that a “floor” is selected as a defective item, and “stain spot” is selected as the content of the defect.

Moreover, an explanation will be given of a case where, for example, a filling space 310 shown in FIG. 3 is an area surrounded by coordinate values (xx3, yy3), (xx3, yy4), (xx4, yy3) and (xx4, yy4), and characters “stain spot in toilet” is filled in the filling space. According to the table A, the “recognition target” of an area corresponding to the filling space 310 is “arbitrary characters”. Accordingly, as the control unit 110 recognizes that characters “stain spot in toilet” are filled in the filling space 310 as shown in FIG. 4 using an arbitrary conventional character recognition scheme, the control unit 110 determines that an informative matter is filled relative to a defective item “floor”.

The control unit 110 extracts the contents of handwritten information filled in an area corresponding to inspection list information in the foregoing fashion. In the example shown in FIG. 4, in addition to the above-explained information, the control unit 110 eventually determines that “peeling” is selected as the defective content of a defective item “wall”, “stripping” is selected as the defective content of a defective item “fitting”, and “bad smell” is selected as the defect content of a defective item “system kitchen”. As explained above, for all filling areas, a “recognition target” and an “operational process” of each filling area in the table A.

As explained above, when analysis of all handwritten information in areas disposed in the inspection list information are completed, the control unit 110 starts a creation process of a work instruction for a maintenance/repair subcontract company (step S508).

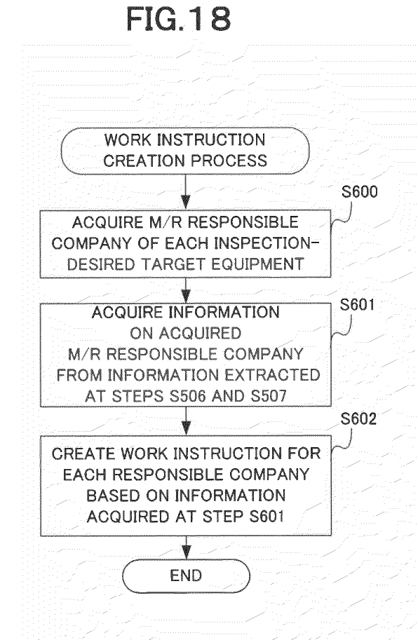

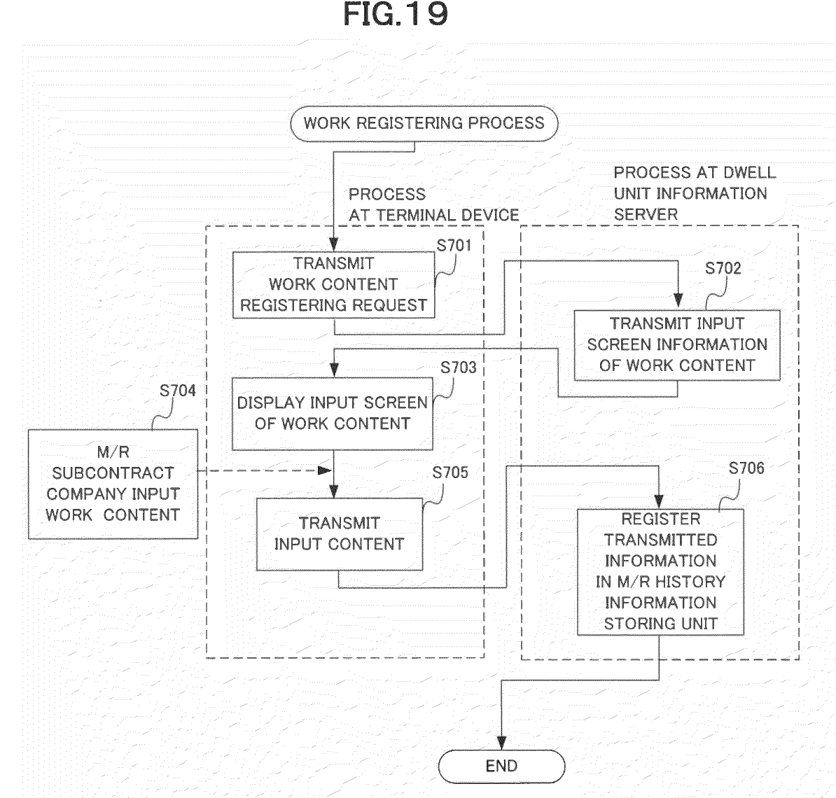

FIG. 18 shows the flow of a work instruction creation process. The control unit 110 determines that each of the defective items determined as to be selected in the inspection lists analyzed in the step S507 are equipments that inspection is requested. Accordingly, the control unit 110 refers to the responsible company information storing unit 133, and acquires a maintenance/repair responsible company for the equipment that inspection is requested (step S600). For example, for the room 708 of a condominium building specified by the condominium building identification information M001, the responsible company for a “system kitchen” is a company identified by company identification information COO I as shown in FIG. 9C.

In the embodiment, for some equipments, such as a “floor”, a “wall”, and a “fitting”, different companies can be set depending on a room where such equipments are provided. When a “floor”, a “wall”, and a “fitting” are equipments that inspection is requested, the control unit 110 specifies a responsible company for each room corresponding to a position where each mark acquired at the step S506 is laid out.

For example, as shown in table X in FIG. 9C, and as shown in the responsible company information storing unit 133, responsible companies differ for a “western style room”, a “living room”, a “toilet”, and a “kitchen” in regard to a “floor”. Accordingly, the control unit 110 determines whether or not there is a mark laid out at an area corresponding to a “floor” among the marks acquired at the step S506. When a mark laid out at an area corresponding to the “floor” is filled, the control unit 110 acquires room information where the mark is located. In the floor plan area of the inspection sheet shown in FIG. 4, the floor of a toilet and the floor of a living room are both marked. The control unit 110 refers to the table X, and specifies that a company identified by company identification information C001 is the responsible maintenance/repair company for the floor of the toilet, and specifies that a company identified by company identification information C002 is the responsible maintenance/repair company for the floor of the living room.

The control unit 110 acquires a responsible company for each defective item listed on the inspection lists in this fashion. Subsequently, the control unit 110 extracts information on a responsible company from information extracted at the step S506 and the step S507 (see FIG. 17), for responsible companies acquired respectively (step S601). For example, since the company identified by the company identification information C001 is responsible for maintenance/repair of the floor of the toilet, the floor of the kitchen, and the system kitchen, when black circles indicating a “floor” are present at the toilet and the kitchen in an area of the floor plan of a currently-processing handwritten information, the control unit 110 leaves the black circles but deletes marks present at other areas. When it is determined that there is an informative matter for a “floor” or a “system kitchen” in the inspection lists of the handwritten information, the control unit 110 acquires the written content.

Based on the information acquired at the step S601, the control unit 110 creates a work instruction for each maintenance/repair company (step S602). For example, for the company identified by the company identification information C001, a work instruction shown in FIG. 5 is created, and for the company identified by the company identification information C002, a work instruction shown in FIG. 6 is created.

At this time, a unique order number (e.g., serial number) is added to each maintenance/repair target equipment. Next, returning to FIG. 17, the control unit 110 registers the order number, condominium building identification information and a room number for specifying a dwell unit having the maintenance/repair target equipment, the name of the maintenance/repair target equipment, the content of defect, and company identification information of a maintenance/repair responsible company responsible for the maintenance/repair target equipment in the maintenance/repair history information storing unit 135 (step S509).

Subsequently, the control unit 110 creates a mail to which a created work instruction is attached, and transmits the mail to the mail address of a company defined by company identification information stored in the company information storing unit 137 (step S510).

(Work Registering Process)

As explained above with reference to FIG. 2, a maintenance/repair subcontract company operates a terminal device connected to the network 5, views a transmitted work instruction, and carries out a maintenance/repair work in accordance with the work instruction. When the work is completed, the maintenance/repair subcontract company operates the terminal device, logs in to the dwell-unit-management supporting application provided by the dwell unit information server 1 via the network 5, and selects a function of registering the work content from a displayed menu screen (FIG. 11C). Accordingly, a work registering process is started.

The work registering process will be explained with reference to FIG. 19. A terminal device transmits a work-content-registering-screen request to the dwell unit information server 1 (step S701). The dwell unit information server 1 transmits information on an input screen which enables registration of a work content to the terminal where the request is made (step S702). The terminal device displays an input screen based on the received input screen information (step S703). Based on the display screen, the maintenance/repair subcontract company inputs the work content (step S704). For example, an order number written on a work instruction, the name of a maintenance/repair target equipment associated with the order number, condominium building identification information of a dwell unit having the maintenance/repair target equipment, a room number, a maintenance/repair work content performed on the maintenance/repair target equipment, a manufacturer name of a replaced part, a model number thereof when a part is replaced, and a maintenance/repair date are input.

As the responsible company operates the terminal device to transmit the input content, the terminal device transmits a registration request to the dwell unit information server 1 (step S705). The control unit 110 of the dwell unit information server 1 registers the transmitted work content in the maintenance/repair history information storing unit 135 based on the transmitted order number (step S706). More specifically, the control unit 110 searches a record having the same order number as the transmitted order number among records stored in the maintenance/repair history information storing unit 135, and adds and registers the transmitted information to the searched record.

The control unit 110 of the dwell unit information server 1 provides work register information on a specified dwell unit to the construction company in response to the request therefrom. More specifically, as the construction company accesses a dwell-unit-management-supporting web application from a terminal device connected to the network 5, and specifies the order number of a work instruction, the control unit 110 reads out a work content associated with the order number from the maintenance/repair history information storing unit 135, and transmits the read-out work content to the terminal device where request is made.

At this time, when a work is already completed, a work content is displayed on the screen of the terminal device. Conversely, when the work is not completed yet, a work content is not registered in the maintenance/repair history information storing unit 135, no work content is displayed on the screen of the terminal device.

Note that information on whether or not a maintenance/repair work for a dwell unit of a dweller may be stored in the maintenance/repair history information storing unit 135, and that dweller may check the information. Accordingly, even if a maintenance/repair work is not completed entirely, a dweller can check whether or not a maintenance/repair work for the dweller's dwell unit is completed.

As explained above, according to the embodiment, an inspection sheet for a dwell unit is automatically created by specifying the dwell unit. The dweller of the dwell unit prints out the inspection sheet, and fills information on an equipment that inspection is requested by handwriting, and causes the multiple function processing machine to read handwritten information. Then, a work instruction is automatically created, and the created work instruction is transmitted to a maintenance/repair responsible company which is responsible for maintenance/repair.

Accordingly, it is possible to reduce a work burden that a construction company creates an inspection sheet, or creates a work instruction for maintenance/repair. Since a time necessary for such work is reduced, a time from when a dweller fills an inspection sheet to when a maintenance/repair work is actually carried out is shortened. Further, because a dweller can send/receive an inspection sheet with the construction company using the multiple function processing machine 2 at his/her own convenience, there is no time limitation. It is not necessary for the construction company and the management company to ensure man power for receiving/collecting inspection sheets, so that a labor cost can be saved. There is also an advantage that an elder person who is not familiar with a computer can enjoy an after-sales service by simply filling an inspection sheet and causing the multiple function processing machine 2 to read it.

An embodiment of the present invention has been explained above, but the present invention can be changed and modified in various forms, and the embodiment of the present invention is not limited to the foregoing embodiment.

For example, a work completion scheduled date may be recorded in the maintenance/repair history information storing unit 135. In this case, when receiving a work instruction, a maintenance/repair responsible company registers a work completion scheduled date in the maintenance/repair history information storing unit 135. When a construction company refers to the maintenance/repair history information storing unit 135 based on an order number, if a work is not completed yet (i.e., if no work information is stored in the maintenance/repair history information storing unit 135), a work completion scheduled date will be displayed.

Moreover, according to the embodiment, the explanation has been given of a case where a purchaser is a dweller of a condominium building dwell unit, but it is expected that a purchaser gives a third person the loan of a dwell unit. In this case, a management company may be allowed to print an inspection sheet from the multiple function processing machine 2 instead of the purchaser. More specifically, when the dwell unit information server 1 determines that a log-in user ID when the dwell-unit-management supporting application is to be used indicates a user belonging to a management company, the user is allowed to print an inspection sheet created for a condominium building dwell unit managed by the management company. The management company gives the printed inspection sheet to the loaner, and causes the loaner to fill the inspection sheet. The management company receives the filled inspection sheet from the loaner, and causes the multiple function processing machine 2 to read the inspection sheet instead of the purchaser.

The kind of the after-sales service is not limited to inspection and maintenance/repair. For example, based on a maintenance/repair history periodically stored in the maintenance/repair history information storing unit 135, the dwell unit information server 1 may create a list of services that a service providing company tied up with the construction company can provide for each dweller of a dwell unit registered on the dwell-unit-management supporting system 10.

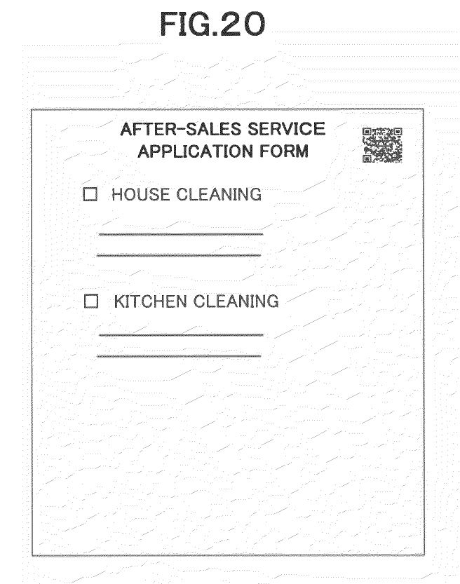

More specifically, when the control unit 110 of the dwell unit information server 1 refers to the maintenance/repair history information storing unit 135 and determines that a dwell unit where maintenance/repair for a bad smell at a kitchen or a stain spotting on a wall is carried out is stored, for the resident of the dwell unit, the control unit 110 may create an application form as a fill-in sheet for requesting a service to a cleaning company specialized for kitchen or a house cleaning company which is tied up with the construction company (see FIG. 20). Here, let us suppose that the dwell unit information server 1 stores information on a service providing company related to each equipment beforehand. A dweller who wants a service prints an application form, and checks a check box corresponding to a service that the dweller wants in the list, and causes the multiple function processing machine 2 to read the application form.

Like the inspection lists, code information including condominium building identification information and a room number for specifying a dwell unit where the application form is provided are printed on the application form in addition to vendor identification information and document identification information for the application form. The multiple function processing machine 2 extracts handwritten information and the code information through the same procedures as the procedures from the step S401 to the step S408. The dwell unit information server 1 stores the document identification information for identifying the application form and an application program for processing the application form in the document information storing unit 134 beforehand in association with each other.

As the dwell unit information server 1 receives the code information and the handwritten information from the multiple function processing machine 2, the dwell unit information server 1 activates the application associated with the document identification information, passes the handwritten information to the application, and extracts information filled on the application form through the same procedure as the step S507. Here, let us suppose that the dwell unit information server 1 has filling-area-coordinate information for the application form. The dwell unit information server 1 executes the same process as the process from the step S508 to the step S510, creates an instruction of providing a checked service, and transmits the instruction to a company which provides such a service. It is necessary that a service content, information which associates a service providing company, and the contact information of the service providing company are stored in the dwell unit information server 1 beforehand. Using the code information included in a fill-in sheet in this fashion makes it possible to provide various after-sales services relating to a dwell unit using the multiple function processing machine 2.

According to the foregoing embodiment, functions provided by the dwell unit information server 1 are utilized by allowing a resident or the like of a condominium building to fill out necessary information in a fill-in sheet. However, in addition to this fashion, inputting of all information necessary to utilize the function provided by the dwell unit information server 1 can be carried out by filling out it in a fill-in sheet on which an image on the basis of code information including document identification information is printed. For example, in the foregoing embodiment, a maintenance/repair subcontract company accesses the dwell unit information server 1 using a terminal device, and registers a maintenance/repair work content, but a work instruction shown in FIG. 5 and FIG. 6 may be provided with code information including document identification information and a filling space for a work content corresponding to each inspection item, and the maintenance/repair company may be allowed to fill a work content in the filling space.

In this case, the dwell unit information server 1 stores document identification information for identifying a work instruction and an application program for processing the work instruction in the document information storing unit 134 beforehand in association with each other. Moreover, the dwell unit information server 1 stores information on a table which registers coordinates of an area where a user can fill information in the work instruction in the filling-area-coordinate information at the dwell unit information storing unit 132 beforehand.

As the maintenance/repair company fills a work content and causes the multiple function processing machine 2 to read the work content, the dwell unit information server 1 activates the application associated with the document identification information. By running the application, the dwell unit information server 1 refers to a table indicated by the filling-area-coordinate information in the dwell unit information server 132 on the basis of handwritten information, and extracts information filled in the work instruction through the same procedure as the step S507. Next, the dwell unit information server 1 stores the extracted information in the maintenance/repair history information storing unit 135 through the same procedure as the step S706.

The dwell-unit-management supporting system 10 of the foregoing embodiment may be applied to not only collective housings but also one-unit homes to support management thereof. That is, for one-unit homes, inspection sheets or work instructions may be automatically created.

In the foregoing embodiment, the explanation has been given of the case where the control program for the dwell unit information server 1 and the control program for the multiple function processing machine 2 are stored in the respective storage unit or the like beforehand. However, such a control program may be stored in a recording medium, such as a flexible disc, a CD-ROM (Compact Disc Read-Only Memory), a DVD (Digital Versatile Disc), an MO (Magneto-Optical disc), or a USB memory, and may be distributed. In this case, the dwell unit information server 1 or the multiple function processing machine 2 has a reader device for such a recoding medium, reads the control program from the recording medium loaded in the reader device, and executes the read control program.

The control program may be stored in a disk device of a predetermined server device over a network, and may be downloaded to the dwell unit information server or the multiple function processing machine. Furthermore, the foregoing processes can be executed by activating and running a program transferred on a communication network.

It is not necessary that the dwell unit information server 1 is realized by a CPU executing a program, but can be realized by exclusive hardwares.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2008-072334 filed on Mar. 19, 2008 and including specification, claims, drawings and summary. The disclosure of the above Japanese Patent Application is incorporated herein by reference in its entirety.

What is claimed is:

1. A dwell-unit-management supporting system comprising a multiple function processing machine and a server providing composition information of a fill-in sheet for dwell unit management to the multiple function processing machine, and wherein:
the composition information includes code information;
the multiple function processing machine comprises:
a printer unit that receives the composition information from the server and prints a fill-in sheet on the basis of the composition information;
a reader unit that reads the fill-in sheet which is printed out by the printer unit and on which a character or a graphic symbol is written;
a read-out information analysis unit that analyzes read-out information read by the reader unit, and extracts the code information and handwritten information, including a character or a graphic symbol, from the read-out information; and
an information transmission unit that transmits the extracted code information and handwritten information when a predetermined transmission condition is satisfied; and
the server comprises:
a reception unit that receives the code information and the handwritten information from the multiple function processing machine; and
a processing unit that executes a predetermined dwell-unit-management supporting process based on the code information and handwritten information both received by the reception unit.

2. The dwell-unit-management supporting system according to claim 1, wherein
the code information includes vendor identification information for specifying a management company of the server, and
the information transmission unit transmits the extracted code information and handwritten information upon satisfying a condition that the vendor identification information included in the code information received by the reception unit matches identification information of a vendor which specifies the management company of the server.

3. The dwell-unit-management supporting system according to claim 1, wherein
the server further comprises a responsible company information storing unit that stores each equipment of a dwell unit, company identification information for specifying a company responsible for maintenance/repair of the equipment, and contact information of the responsible company in association with one another for each dwell unit subjected to management, and
the processing unit determines whether or not the handwritten information includes information indicating that an inspection-desired equipment at a specific dwell unit is filled based on the received code information and handwritten information, and when determining that such information is included, as the dwell-unit-management supporting process, specifies an inspection-desired equipment in the dwell unit based on the handwritten information, searches identification information of a company responsible for maintenance/repair of the specified inspection-desired equipment from the responsible company information storing unit, creates a work instruction instructing inspection of the inspection-desired equipment to the responsible company identified by the searched company identification information, and transmits the work instruction to the contact information of the responsible company.

4. The dwell-unit-management supporting system according to claim 3, wherein
the server further comprises a maintenance/repair history information storing unit that stores a work content done by a maintenance/repair responsible company in accordance with the work instruction for each dwell unit subjected to management, and
the processing unit determines whether or not the handwritten information includes information indicating that a maintenance/repair work content at a dwell unit is filled based on the received code information and handwritten information, and when determining that such information is included, as the dwell-unit-management supporting process, extracts a maintenance/repair work content at the dwell unit based on the handwritten information, and stores the extracted information in the maintenance/repair history information storing unit.

5. The dwell-unit-management supporting system according to claim 1, wherein
the server further comprises:
a dwell unit information storing unit that stores identification information of a dwell unit and information on the dwell unit in association with each other for each dwell unit subjected to management; and
a composition information creation unit that searches information on a dwell unit corresponding to identification information in the dwell unit information storing unit when a request of creating the document composition information including the identification information of the dwell unit is received, and creates the composition information including the code information based on the information on the dwell unit.

6. The dwell-unit-management supporting system according to claim 5, wherein
information on a dwell unit includes floor plan information of the dwell unit and inspection list information, and
the composition information is constituted in a manner that a floor plan of a dwell unit and an inspection list for the dwell unit on the basis of the floor plan information and the inspection list information are printed on the fill-in sheet.

7. A dwell-unit-management supporting method carried out by a multiple function processing machine, and a server that provides composition information of a fill-in sheet for dwell unit management to the multiple function processing machine, wherein:
the composition information includes code information; and
the method comprises:
a print step of receiving the composition information created by the server, and printing a fill-in sheet based on the composition information using the multiple function processing machine;
a reading step of reading the fill-in sheet which is printed and on which a character or a graphic symbol is written using the multiple function processing machine;
a read-out information analyzing step of analyzing read information read out using the multiple function processing machine, and extracting the code information and handwritten information including a character or a graphic symbol from the read information using the multiple function processing machine;
an information transmission step of transmitting the extracted code information and handwritten information using the multiple function processing machine when a predetermined transmission condition is satisfied;
a reception step of receiving the code information and the handwritten information from the multiple function processing machine using the server; and
a processing step of executing a predetermined dwell-unit-management supporting process based on the received code information and handwritten information using the server.

8. A computer-readable recording medium storing a program that allows a computer to function as a server which provides composition information of a fill-in sheet for dwell unit management to a multiple function processing machine, wherein:
the composition information includes code information; and
the server comprises:
a reception unit that receives code information included in a fill-in sheet provided by the multiple function processing machine and handwritten information on a character or a graphic symbol which is written on the fill-in sheet from the multiple function processing machine; and
a processing unit that executes a predetermined dwell-unit-management supporting process based on the code information and the handwritten information both received by the reception unit.

9. A computer-readable recording medium storing a program that allows a computer to function as a multiple function processing machine to which composition information of a fill-in sheet for dwell unit management is provided from a server, wherein:
the composition information includes code information;
the multiple function processing machine comprises:
a printer unit that receives the composition information from the server and prints a fill-in sheet on the basis of the composition information;
a reader unit that reads the fill-in sheet which is printed out by the printer unit and on which a character or a graphic symbol is written;
a read-out information analysis unit that analyzes read-out information read by the reader unit, and extracts the code information and handwritten information on a character or a graphic symbol written on the fill-in sheet from the read-out information; and
an information transmission unit that transmits the extracted code information and handwritten information when a predetermined transmission condition is satisfied.

10. A server that provides composition information of a fill-in sheet for dwell unit management to a multiple function processing machine, wherein
the composition information includes code information; and
the server comprises:
a reception unit that receives code information included in a fill-in sheet provided to the multiple function processing machine and handwritten information on a character or a graphic symbol written on the fill-in sheet from the multiple function processing machine; and
a processing unit that executes a predetermined dwell-unit-management supporting process based on the code information and the handwritten information both received by the reception unit.

11. A multiple function processing machine that is connected to a server which provides composition information of a fill-in sheet for dwell unit management, wherein
the composition information includes code information;
the multiple function processing machine comprises:
a printer unit that receives the composition information from the server and prints a fill-in sheet on the basis of the composition information;
a reader unit that reads the fill-in sheet which is printed out by the printer unit and on which a character or a graphic symbol is written;
a read-out information analysis unit that analyzes read-out information read by the reader unit, and extracts the code information and handwritten information on a character or a graphic symbol written on the fill-in sheet from the read-out information; and
an information transmission unit that transmits the extracted code information and handwritten information when a predetermined transmission condition is satisfied.
